(19) United States
(12) Patent Application Publication
(10) Pub. No.: US 2024/0319354 A1
(43) Pub. Date: Sep. 26, 2024

(54) DOPPLER PROCESSING IN RF SENSING FOR CELLULAR SYSTEMS

(71) Applicant: QUALCOMM Incorporated, San Diego, CA (US)

(72) Inventors: Marwen ZORGUI, San Diego, CA (US); Srinivas YERRAMALLI, San Diego, CA (US); Balwinderpal SACHDEV, San Diego, CA (US)

(21) Appl. No.: 18/186,867

(22) Filed: Mar. 20, 2023

(51) Int. Cl. G01S 13/50; H04L 5/00; H04W 64/00

(52) U.S. Cl. CPC G01S 13/505; H04L 5/0048; H04W 64/006

(57) ABSTRACT

Apparatuses and methods for Doppler processing in RF sensing for wireless/cellular systems are described. An apparatus is configured to configure a uniform sampling periodicity for a set of Doppler operations based on a sampling configuration. The uniform sampling periodicity is different from a non-uniform periodicity or a uniform periodicity of a received reference signal. The apparatus is also configured to measure, based on the received reference signal, sensing measurement data associated with at least one sensing target. The apparatus is also configured to process one or more of the set of Doppler operations for at least one portion of the sensing measurement data according to the uniform sampling periodicity.

### TECHNICAL FIELD

The present disclosure relates generally to communication systems, and more particularly, to wireless communications utilizing sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to configure a uniform sampling periodicity for a set of Doppler operations based on a sampling configuration, where the uniform sampling periodicity is different from a non-uniform periodicity or a uniform periodicity of a received reference signal. The apparatus is also configured to measure, based on the received reference signal, sensing measurement data associated with at least one sensing target. The apparatus is further configured to process one or more of the set of Doppler operations for at least one portion of the sensing measurement data according to the uniform sampling periodicity.

In the aspect, the method includes configuring a uniform sampling periodicity for a set of Doppler operations based on a sampling configuration, where the uniform sampling periodicity is different from a non-uniform periodicity or a uniform periodicity of a received reference signal. The method also includes measuring, based on the received reference signal, sensing measurement data associated with at least one sensing target. The method further includes processing one or more of the set of Doppler operations for at least one portion of the sensing measurement data according to the uniform sampling periodicity.

In an aspect of the disclosure, a method, a computer-readable medium, and an apparatus are provided. The apparatus is configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The apparatus is also configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity.

In the aspect, the method includes transmitting, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The method also includes receiving, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating examples of Doppler processing and cyclic prefix (CP) lengths for radio frequency (RF) sensing, in accordance with various aspects of the present disclosure.

FIG. 6 is a call flow diagram for wireless communications, in accordance with various aspects of the present disclosure.

FIG. 7 is a diagram illustrating examples of uniform periodic sampling and Doppler processing for RF sensing, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

Wireless communication networks, such as a 5G NR network, may enable sensing measurements and operations for wireless devices. For example, a wireless communication network and/or a wireless device may utilize specific waveforms for communications, such as orthogonal frequency division multiplexing (OFDM), and for sensing (RF). RF sensing operations may include scanning an area by sweeping across one or more beams. RF waveforms may be utilized for joint communications-sensing (JCS), environment scanning, object detection, weather monitoring, and/or the like. The use of RF waveforms for sensing may provide for low cost, allow flexibility, and allow the re-use of sensing waveforms for multiple purposes. Wireless communication networks may support and enable sensing and collection of sensing measurement data, NR-based sensing measurement data for processing (e.g., Doppler processing), processing sensing measurement data and associating the sensing measurement data with other assisted information (e.g., location information), exposing sensing measurement data via a core network, etc.

However, Doppler processing may include computational complexities associated with some algorithms, e.g., super-resolution algorithms. Such complexities may be prohibitive for UE-based processing, including but not limited to, real-time, or near real-time, applications. Further, Doppler processing may utilize fast Fourier transforms (FFTs), and FFT-based processing may assume that the signal to be processed is sampled uniformly in time or in frequency in the case of range processing. Yet, the slot structure in NR may prohibit guarantees of uniform sampling in the time domain of reference signals in some scenarios.

Various aspects relate generally to wireless communications systems and sensing operations for wireless devices. Some aspects more specifically relate to Doppler processing in RF sensing for wireless/cellular systems. In one example, a sensing node may be configured to configure a uniform sampling periodicity for a set of Doppler operations based on a sampling configuration, where the uniform sampling periodicity is different from a non-uniform periodicity or a uniform periodicity of a received reference signal. The sensing node may also be configured to measure, based on the received reference signal, sensing measurement data associated with at least one sensing target. The sensing node may further be configured to process one or more of the set of Doppler operations for at least one portion of the sensing measurement data according to the uniform sampling periodicity. In another example, the sensing node may be configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The sensing node may also be configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity.

Particular aspects of the subject matter described in this disclosure can be implemented to realize one or more of the following potential advantages. In some examples, by configuring a sensing node with a uniform sampling periodicity for Doppler operations, the described techniques can be used to enable, simplify, and more efficiently perform the Doppler operations, including FFTs, at a sensing node. In some examples, by extracting or sampling periodic measurement sub-sequences from RF measurements, the described techniques can be used to perform Doppler processing on periodic measurements. In some examples, by configuring reference signals without extra CP lengths, the described techniques can be used to provide/transmit periodic reference signals that have the same CP in all associated resources.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS. 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

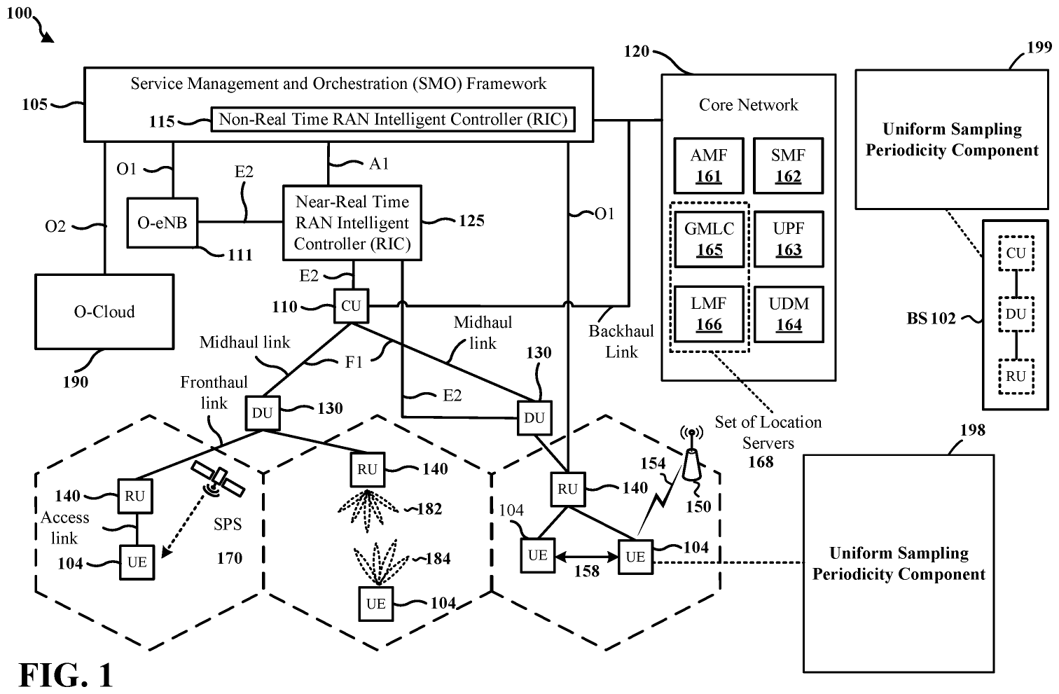

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHz-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a uniform sampling periodicity component 198 (“component 198”) that may be configured to configure a uniform sampling periodicity for a set of Doppler operations based on a sampling configuration, where the uniform sampling periodicity is different from a non-uniform periodicity or a uniform periodicity of a received reference signal. The component 198 may also be configured to measure, based on the received reference signal, sensing measurement data associated with at least one sensing target. The component 198 may further be configured to process one or more of the set of Doppler operations for at least one portion of the sensing measurement data according to the uniform sampling periodicity. The component 198 may be configured to transmit, for a sensing entity, a set of results of processing the one or more of the set of Doppler operations for the at least one portion of the sensing measurement data. The component 198 may be configured to receive, from the sensing entity, the sampling configuration prior to the configuration of the uniform sampling periodicity, where the sampling configuration indicates the uniform sampling periodicity for the set of Doppler operations. In certain aspects, the base station 102 may have a uniform sampling periodicity component 199 (“component 199”) that may be configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The component 199 may also be configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity. That is, aspects provide for Doppler processing in RF sensing for wireless/cellular systems that enable configuring sensing nodes with multiple hypotheses for performing and reporting sensing operations. Aspects herein enable simplified and more efficient performance of Doppler operations for RF sensing, including FFTs, at sensing nodes are enabled by configuring sensing nodes, such as UEs/TRPs, with a uniform sampling periodicity for Doppler operations. Aspects also enable perform Doppler processing on periodic measurements through extraction (e.g., sampling) of periodic measurement sub-sequences from RF measurements. Aspects further enable provision/transmission of periodic reference signals that have the same CP in all associated resources by configuring reference signals without extra CP lengths.

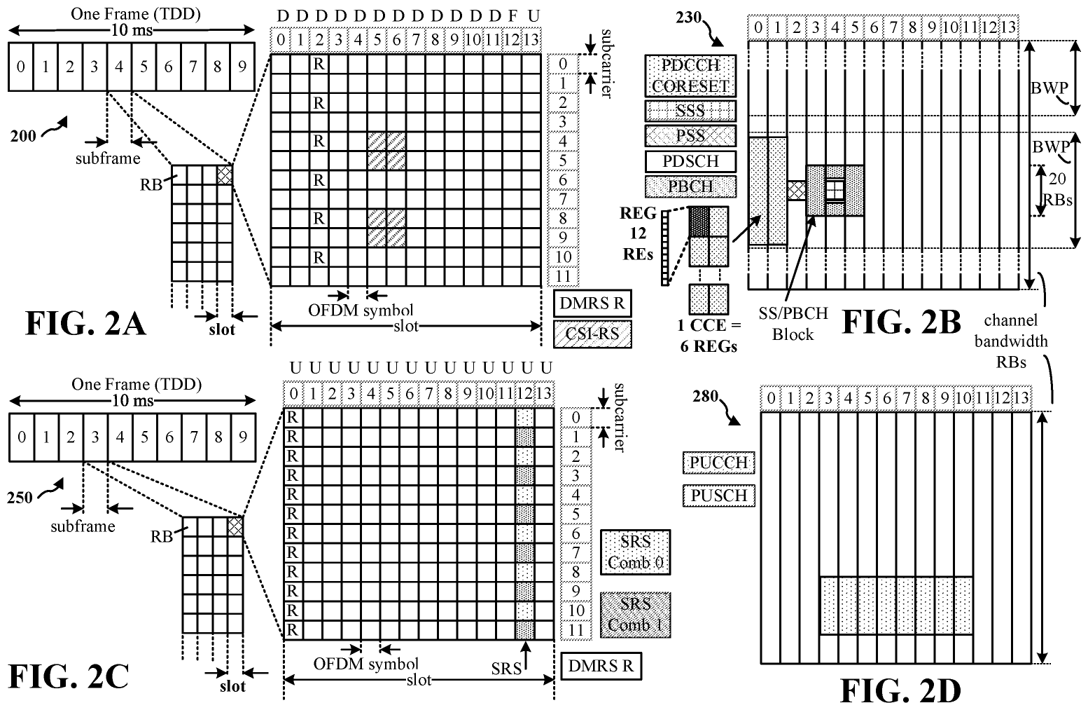

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

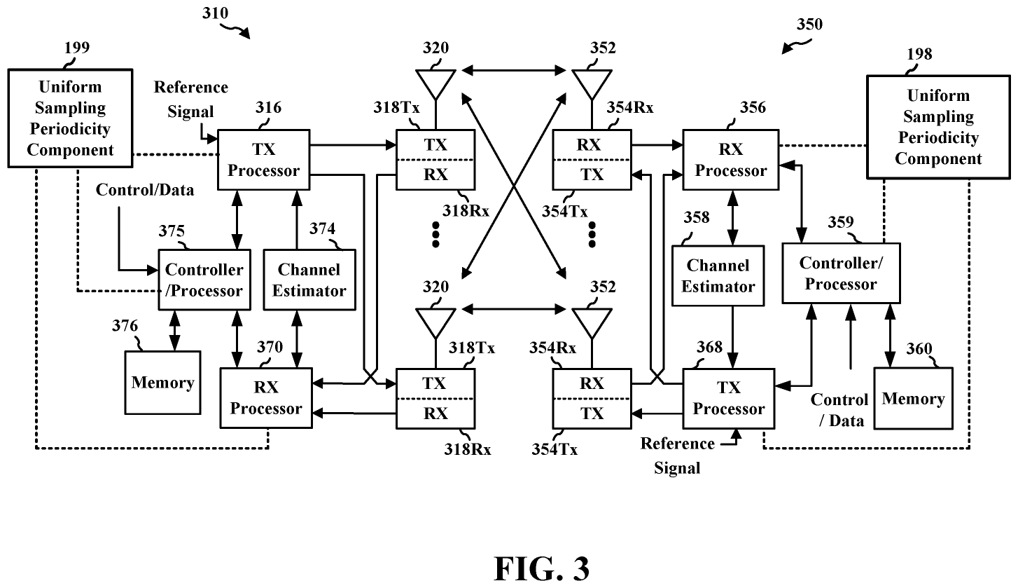

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

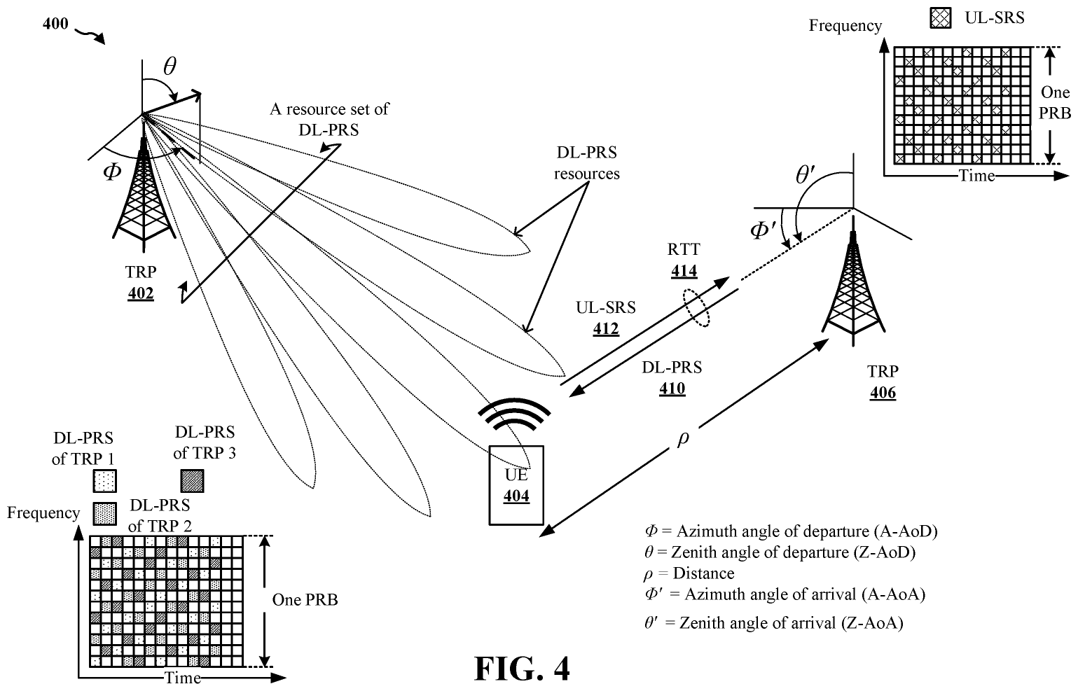

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx−Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx−Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx−Tx time difference measurements (and optionally DL-PRS-RSRP of the received signals) using assistance data received from the positioning server, and the TRPs 402, 406 measure the gNB Rx−Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an access point (AP), etc.) may also be configured to include sensing capabilities, where the wireless device may be able to sense (e.g., detect and/or track) one or more objects or target entities of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. An RF sensing session may be referred to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc.

Specific waveforms may be utilized for communications, e.g., OFDM, and for sensing, e.g., RF, in wireless communication networks/wireless devices. In some cases, RF sensing operations may include scanning an area by sweeping across one or more beams. RF waveforms may be utilized for JCS, environment scanning, object detection, weather monitoring, and/or the like. The use of RF waveforms for sensing may provide for low cost, allow flexibility, and allow the re-use of sensing waveforms for multiple purposes. Wireless communication networks may support and enable sensing and collection of sensing measurement data, NR-based sensing measurement data for processing (e.g., Doppler processing), processing sensing measurement data and associating the sensing measurement data with other assisted information (e.g., location information), exposing sensing measurement data via a core network, etc. However, computational complexities associated with some algorithms, e.g., super-resolution algorithms may hinder performance of operations, or the ability to perform the operations. Such complexities may be prohibitive for UE-based processing, including but not limited to, real-time, or near real-time, applications. Further, Doppler processing may utilize FFTs, and FFT-based processing may assume that the signal to be processed is sampled uniformly in time or in frequency in the case of range processing. Yet, the slot structure in NR may prohibit guarantees of uniform sampling in the time domain of reference signals in some scenarios.

The described aspects for sensing operations, e.g., for Doppler processing in RF sensing for wireless/cellular systems, enable wireless and network devices to more simply and efficiently perform Doppler processing on RF measurements. In one example, a sensing node may be configured to configure a uniform sampling periodicity (e.g., sampling of data at/over a recurring time interval, where uniform sampling periodicity includes a same interval for each iteration of the sampling) for a set of Doppler operations based on a sampling configuration, where the uniform sampling periodicity (e.g., a periodicity for which all iterations are of equal length) is different from a non-uniform periodicity (e.g., a periodicity for which all iterations are not of equal length) or a uniform periodicity of a received reference signal. The sensing node may also be configured to measure, based on the received reference signal, sensing measurement data (e.g., data obtained from performing sensing measurements on a signal) associated with at least one sensing target. The sensing node may further be configured to process one or more of the set of Doppler operations for at least one portion of the sensing measurement data according to the uniform sampling periodicity. In another example, the sensing node may be configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The sensing node may also be configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity.

Aspects herein enable simplified and more efficient performance of Doppler operations for RF sensing, including FFTs, at sensing nodes are enabled by configuring sensing nodes, such as UEs/transmission-reception points (TRPs), with a uniform sampling periodicity for Doppler operations. Aspects also enable perform Doppler processing on periodic measurements through extraction or sampling of periodic measurement sub-sequences from RF measurements. Aspects further enable provision/transmission of periodic reference signals that have the same CP in all associated resources by configuring reference signals without extra CP lengths, e.g., for PRS and/or SRS for positioning (SRS-pos). Additionally, aspects herein for Doppler processing in RF sensing for wireless/cellular systems are applicable to 5G NR and may also be extended to 5G Enhanced and 6G applications. As one example, in current and future generations of wireless/cellular systems, the described aspects provide for RF sensing with dedicated frequency domain resources and/or time domain resources for sensing operations, e.g., for Doppler.

While various aspects may be described in the context of Doppler processing in RF sensing for wireless/cellular systems for descriptive and illustrative purposes, aspects are not so limited and may be applicable to other types of operations and resources, as would be understood by persons of skill in the relevant art(s) having the benefit of this disclosure.

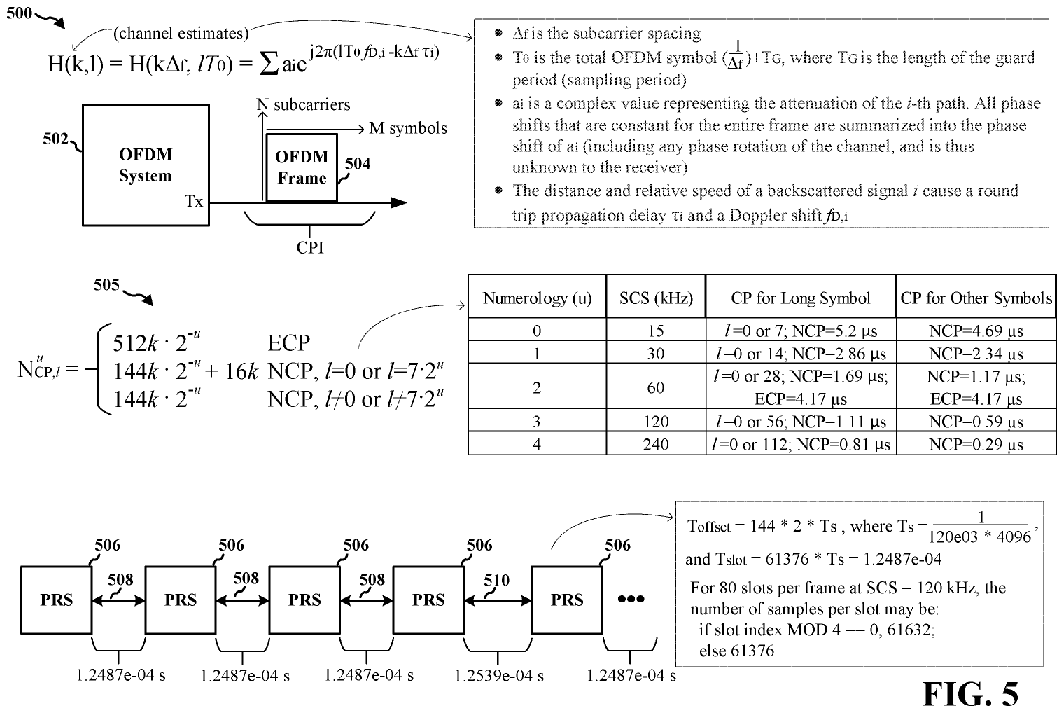

FIG. 5 is a diagram 500 illustrating examples of Doppler processing and CP lengths for RF sensing, in various aspects. RF sensing operations may include scanning an area by sweeping across one or more beams, and performing Doppler processing on measurement obtained by the RF sensing operations. Diagram 500 shows an OFDM system 502 in the context of Doppler processing, as well as a CP configuration 505 and a PRS 506, by way of example, in the context of CP lengths.

As noted herein, Doppler processing may be one of the types of measurement processing utilized in RF sensing. Doppler processing may enable estimating radial velocities of moving targets by associating Doppler frequencies to radial velocities. Additionally, target motion may correspond to a phase progression term in time domain samples. Referring to the OFDM system 502, an OFDM frame 504 may be transmitted during a coherent processing interval (CPI). The OFDM frame 504 may include ‘N’ subcarriers and ‘M’ symbols, and the channel estimates across frequency and time may be modeled as shown for the equation H(k,l) in diagram 500, with corresponding reference to the subcarrier spacing, the total OFDM symbol, the length of the guard period (sampling period), the attenuation of the paths, constant phase shifts for the OFDM frame 504, the distance and relative speed of backscattered signals, round trip propagation delay, and Doppler shift. The estimation of Doppler frequency f_{D} may equivalent to the detection of the fundamental frequency of a discretely-sampled complex sinusoid (e.g., in white Gaussian noise).

While super-resolution algorithms may be used in the estimation of Doppler frequencies, associated computational complexities may prohibitive for UE-based processing, e.g., in real-time applications. Additionally, while FFT-based processing may be utilized in the Doppler processing (and/or range processing), FFT-based processing may assume that the signal is sampled uniformly in time (or in frequency in the case of range processing). For instance, the illustrated OFDM frame 504 in diagram 500, the equation H(k,l) may assume a uniform sampling with a sampling period T₀ to enable FFT-based processing.

However, the slot structure in NR may prohibit guarantees of uniform sampling in the time domain of reference signals for Doppler processing in some scenarios. In 5G NR, CPs may have two different types: a normal CP (NCP) and an extended CP (ECP) or long CP. The NCP may be specified for all SCSs, and the ECP may be specified for 60 kHz SCS. In cases where NCP is utilized, the CP of the first symbol present every 0.5 ms is longer than that of other symbols, and CP durations may decrease as the SCS increases. As one example with reference to the CP configuration 505 in diagram 500, an equation N^{u}_{CP,l} is provided by which the CP length for different sub-carriers may be calculated.

Illustrative CP durations, e.g., for a 5G NR physical layer timing unit, are illustrated in the table (which may be an extension of Table 1 described above) accompanying the CP configuration 505 in diagram 500, and may be based on the equation N^{u}_{CP,l}. For example, each numerology ‘u’ may include two long symbols per 1 ms sub frame. These longer symbols may be generated by increasing the duration of the NCP so that each numerology ‘u’ may have an integer number of symbols within each 0.5 ms time window, while also providing that as many symbol boundaries as possible coincide, e.g., so that as many symbol boundaries belonging to the 15 kHz SCS as possible coincide with as many second symbol boundaries of the 30 kHz SCS as possible. Accordingly, the slot durations may not be equal.

Regarding non-uniform CP lengths, an example for a 120 kHz SCS is provided below. With 80 slots per frame and a 120 kHz SCS, the number of samples per frame is different based on the slot index as indicated in diagram 500:

61632 Samples Per Frame when the Slot Index MOD 4=0, Based on:

144*2+16*16+4096)*1+(144*2+4096)*13=(544+4096)*1+(288+4096)*13=4640*1+4384*13=1.2539e-04 s; or

### 61376 Samples Per Frame Otherwise, Based on:

$$( 144 * 2 + 40 \; 96 ) * 14 = ( 288 + 40 \; 96 ) * 14 = 4384 * 14 = 1.24 \; 87 e - 04 s .$$

In other words, the slot duration (including CPs) may be variable.

As another example for 5G NR, PRS resource sets may be configured with a periodicity given by an integer number of slots. Instances of a PRS 506 are illustrated in diagram 500, by way of example. For instance, a PRS resource set with a periodicity of 1 slot (“one slot”) may have a PRS sampling interval T₀ that is not uniform. As illustrated for the instances of the PRS 506, the offset time for a given instance may be represented as an equation T_{offset}. As shown, some instances of the PRS 506 may have a slot duration 508 of 1.2487e-04 s, while every fourth instance may have a slot duration 510 of 1.2539e-04 s, which is longer than the slot duration 508. If the resources in the instances of the PRS 506 are sampled at time instants Tₛₗₒₜ, 2*Tₛₗₒₜ, 3*Tₛₗₒₜ, 4*Tₛₗₒₜ, 5*Tₛₗₒₜ, etc., based on diagram 500, then depending on the periodicity and/or the SCS, different, non-uniform sampling patterns may arise may arise for the PRS sampling interval T₀. As noted, FFT-based processing may assume periodic sampling, as non-uniform sampling may introduce performance degradation when FFT-based processing is used. While non-FFT-based processing (e.g., super-resolution algorithms) may be applied at the sensing node (e.g., UE-side/TRP-side), the computational complexity of these algorithms may be prohibitive for practical UE/TRP implementations.

Aspects described herein provide for Doppler processing in RF sensing for wireless/cellular systems that address non-uniform sampling issues.

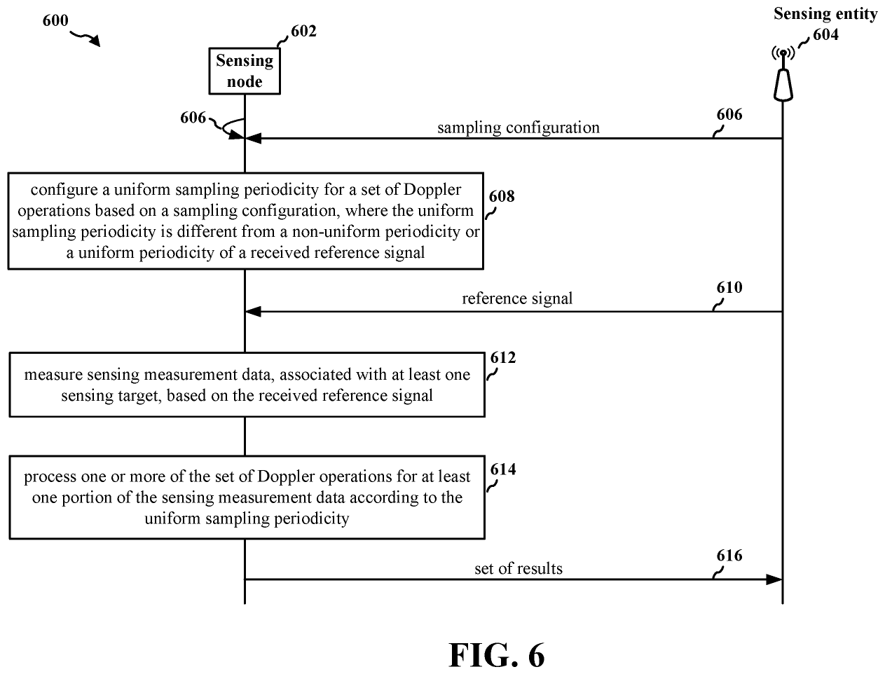

FIG. 6 is a call flow diagram 600 for wireless communications, in various aspects. Call flow diagram 600 illustrates multi-hypothesis measurement configuration in RF sensing for sensing measurements by a sensing node (e.g., a sensing node 602, such as a UE, a sidelink (SL) UE, a TRP, etc.) that may communicate with and/or performing sensing operations with/without a sensing entity (e.g., a sensing entity 604, such as a base station, a gNB, or other type of base station or network node, a network entity such as a LMF, etc., by way of example, as shown). Aspects described for the sensing entity 604 may be performed by the sensing entity in aggregated form and/or by one or more components of the sensing entity 604 in disaggregated form. Additionally, or alternatively, the aspects may be performed by the sensing node 602 autonomously, in addition to, and/or in lieu of, operations of the sensing entity 604.

In the illustrated aspect, the sensing node 602 may be configured to obtain a sampling configuration 606. For Doppler processing, the aspects herein provide for a sensing node, e.g., the sensing node 602, to assume uniform sampling and/or to disregard non-uniform sampling when it exists. For instance, aspects may utilize cases in which any degradation in Doppler processing performed by the sensing node 602 due to non-uniform sampling may be negligible. Thus, a uniform periodicity may be used for the Doppler processing (e.g., FFT-based), and may be configured by the sensing entity 704 (or other network entity/node) or by the sensing node 602 itself.

In aspects, the sensing node 602 may be configured to receive, from the sensing entity 604, the sampling configuration 606 prior to the configuration of a uniform sampling periodicity. The sampling configuration 606 may indicate the uniform sampling periodicity for a set of Doppler operations, e.g., Doppler operations to be performed by the sensing node 602. In aspects, the uniform sampling periodicity for the set of Doppler operations may be a first duration of a first slot that includes a symbol with a long CP, a second duration of a second slot that does not include any symbol with the long CP, a third duration of an average slot length, and/or the like. In some aspects, the sensing node 602 may be configured to obtain the sampling configuration 606 itself by performing operations to calculate characteristics of the uniform sampling periodicity. For instance, the sampling configuration 606 may be obtained by the sensing node 602 based on a length of the uniform sampling periodicity or a frequency of the uniform sampling periodicity. In some aspects the sampling configuration 606 may be obtained by the sensing node 602 through selection that may be based on the sampling configuration 606 as stored by the sensing node 602. For example, the sensing node 602 may select the sampling configuration 606 from one or more options in data structure (e.g., a list or the like) associated with reference signals that are received by the sensing node 602. In some aspects, the sampling configuration 606 may include an indication for the sensing node 602 to provide an indication back to the sensing entity 604 for the uniform sampling periodicity that is configured/utilized.

As one example, for the case where the SCS is 120 kHz, and there are 1-slot periodic PRS resources, the sampling configuration 606 for sensing node 602 may indicate to use T₀=1.2487e-04 s as the sampling period (e.g., for a slot including a symbol with a long CP) or to use T₀=1.2539e-04 s (e.g., the duration of a slot without a symbol having the long CP). In aspects, the sensing entity 604 may indicate in the sampling configuration 606 another value for To, e.g., an average of the slot lengths, such as where T₀=1.25e-04 s.

The sensing node 602 may be configured to configure (at 608) a uniform sampling periodicity for a set of Doppler operations. In aspects, the uniform sampling periodicity may be based on the sampling configuration 606. The uniform sampling periodicity that is configured may be different from a non-uniform periodicity or a uniform periodicity of a received reference signal, e.g., a reference signal 610 described below. In aspects, as noted above for the sampling configuration 606, the node 602 may be configured to configure (at 608) the uniform sampling periodicity by performing operations to calculate characteristics of the uniform sampling periodicity. In aspects for performing such operations, the sensing node 602 may be configured to calculate a length of the uniform sampling periodicity or a frequency of the uniform sampling periodicity. The sensing node 602 may thus be configured to configure the uniform sampling periodicity for itself based on the length of the uniform sampling periodicity and/or the frequency of the uniform sampling periodicity that is/are calculated.

The sensing node 602 may be configured to receive the reference signal 610. The reference signal 610 may be received, and transmitted from the sensing entity 604, another UE, and/or a TRP. The received reference signal 610 may have a uniform periodicity, and each resource associated with the received reference signal 610 may have a same CP with a uniform CP length. In aspects, the uniform periodicity of the received reference signal 610 may not follow prior protocols or standards. In aspects, the same CP with the uniform CP length may be a NCP and/or an ECP. The received reference signal 610 may be a PRS or a SRS-pos. In such aspects, each resource associated with the received reference signal 610 may be a dedicated time domain resource or a dedicated frequency domain resource. In aspects, while the extra CP length may be designed to align signals/channels with other signals/channels, not using a long CP may be carried out in some scenarios. For example, if reference signal transmissions occur in a dedicated frequency domain resource or time domain resources (e.g., a transmission gap), where no other operations are expected, alignment may be unnecessary.

The sensing node 602 may be configured to measure (at 612) sensing measurement data, associated with at least one sensing target, based on the received reference signal 610. For example, the sensing node 602 may measure (at 612), via RF sensing, characteristics of the received reference signal 610 to obtain the sensing measurement data.

The sensing node 602 may be configured to process (at 614) one or more of the set of Doppler operations for at least one portion of the sensing measurement data (e.g., based on the sampling configuration 606) according to the uniform sampling periodicity. In aspects, the sensing node 602 may be configured to process (at 614) one or more of the set of Doppler operations by performing a FFT(s) for at least one portion of the sensing measurement data.

As one example, a portion of the sensing measurement data measured (at 612) may be processed by the sensing node 602 based on a periodic measurement sampling for a sub-sequence of the sensing measurement data, and the sensing node 602 may be configured to process (at 614), via Doppler processing, uniformly periodic measurements through extraction or sampling of periodic measurement sub-sequences from the RF sensing measurements (e.g., at 612). In aspects, a period of the periodic measurement sampling for the sub-sequence of the sensing measurement data may correspond to four slots. In aspects, a sub-sequence may be a sequential set or subset of a sequence, e.g., the sequence of the sensing measurement data, that may be generated based on the periodic measurement sampling (e.g., a less dense set/subset of data obtained by extracting/sampling a datum of the sensing measurement data at an n^{th} instance(s) of the data).

As another example, to process (at 614), the sensing node 602 may be configured to process two or more of the set of Doppler operations for at least two portions of the sensing measurement data according to the periodic measurement sampling for the sub-sequence of the sensing measurement data to generate two or more Doppler outputs, and to calculate an average of the two or more Doppler outputs associated with the two or more of the set of Doppler operations. For instance, the sensing node 602 may be configured to utilize every fourth measurement via uniform measurement sampling of the sensing measurement data to achieve a periodic sequence for a period 4 slots, or 0.5 ms. Additionally, as there may be four possible sub-sequences, each with a different offset, the sensing node 602 may be configured to average the Doppler outputs obtained over each sequence.

The sensing node 602 may be configured to provide/transmit a set of results 616. In aspects, the set of results 616 may be for a set of results of processing (at 614) one or more of the set of Doppler operations for the at least one portion of the sensing measurement data. The sensing node 602 may provide/transmit the set of results 616 to the sensing entity 604.

In aspects, the sensing node 602 may be configured to provide/transmit an indication of the uniform sampling periodicity configured for the set of Doppler operations. For example, in aspects for which the sensing node 602 configures the uniform sampling periodicity itself, as described above, the sensing node 602 may report to the sensing entity 604 the uniform sampling periodicity that was self-configured and/or utilized for the set of Doppler operations so that the sensing entity 604 may be aware of the configured uniform sampling periodicity. In such aspects, the sensing node 602 may be configured to provide/transmit an indication of the uniform sampling periodicity configured for the set of Doppler operations based on the sampling configuration 606.

In aspects, transmitting nodes and/or receiving nodes may be sensing nodes and/or sensing entities, as described herein.

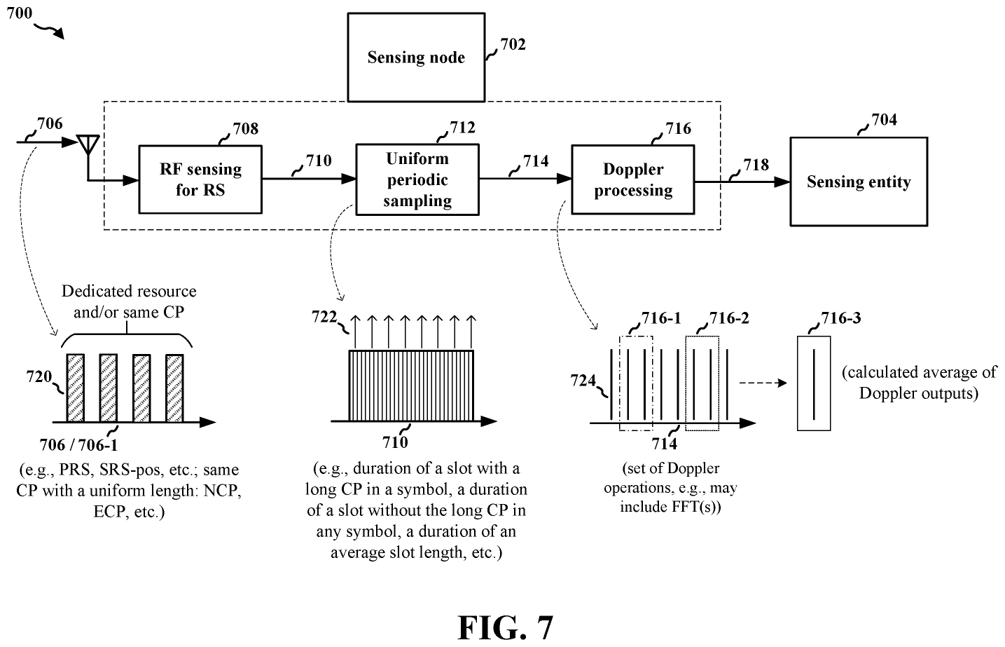

FIG. 7 is a diagram 700 illustrating examples of uniform periodic sampling and Doppler processing for RF sensing, in various aspects. Diagram 700 is illustrated in the context of a sensing node 702 (e.g., a UE/TRP, and/or the like) and a sensing entity 704 (e.g., a base station or other network node, an LMF or other network entity, and/or the like). The sensing node 702 is configured to receive a reference signal 706 and to provide/transmit a set of results 718 of processing one or more of the set of Doppler operations to the sensing entity 704.

As shown in diagram 700, the reference signal 706 may be received by the sensing node 702. The reference signal 706 may be a PRS, a SRS-pos, and/or the like. In aspects, the reference signal 706 may include a set of resources 720. The set of resources 720 may be dedicated resources with respect to time and/or frequency domains. In aspects, each resource of the set of resources 720 may have the same CP, with a uniform length, such as a NCP, ECP, and/or the like. In some aspects, the reference signal 706 may have a uniform periodicity, illustrated as a reference signal 706-1.

The sensing node 702 may be configured to measure (at 708), via RF sensing for RSs and based on the reference signal 706 (or the reference signal 706-1), sensing measurement data 710. In aspects, the sensing measurement data may be associated with at least one sensing target. The sensing node 702 may be configured to sample (at 712) (or extract) the sensing measurement data 710 via uniform periodic sampling to generate at least one portion 714 of the sensing measurement data 710. In aspects, the sensing node 702 may be configured to sample (at 712) based on the uniform sampling periodicity that is configured, as described herein. The uniform sampling periodicity may be configured as a duration of a slot that includes a symbol with a long CP, a duration of a slot that does not include any symbol with the long CP, a duration of an average slot length, and/or the like. As illustrated for the sensing measurement data 710, the sensing node 702 may be configured to may sample (at 712) (or extract) at sampling occasions 722 at least one portion 714 from the sensing measurement data 710 based on the uniform sampling periodicity.

The sensing node 702 may be configured to perform a set of Doppler operations (at 716) based on the at least one portion 714 from the sensing measurement data 710 that is associated with the uniform sampling periodicity. In aspects, the set of Doppler operations are processed (at 716) may include the performance of one or more FFTs. e.g., based on periodically sampled data. As shown in diagram 700 for the set of Doppler operations processed (at 716), e.g., one or more Doppler operations, a first Doppler operation 716-1 and a second Doppler operation 716-2, by way of example, may be processed for portions 724 of the at least one portion 714 from the sensing measurement data 710. That is, sensing node 702 may be configured to process (at 716) the set of Doppler operations for the portions 724, which may represent subsets or sub-sequences of the at least one portion 714 from the sensing measurement data 710. Additionally, in various aspects, there may be multiple sub-sequences possible, and each may have a different offset, as noted above. In scenarios for processing (at 716) more than one of the set of Doppler operations and/or for processing (at 716) more than one of the set of Doppler operations for multiple sub-sequences having different offsets, the sensing node 702 may be configured to calculate averages of Doppler outputs. As one example, the sensing node 702 may be configured to further process (at 716), via a third Doppler operation 716-3, the Doppler outputs obtained over each sequence, or multiple sequences, for Doppler operations (e.g., Doppler outputs for the first Doppler operation 716-1 and the second Doppler operation 716-2) and to calculate an average thereon to generate an average Doppler result as at least a portion of the set of results 718.

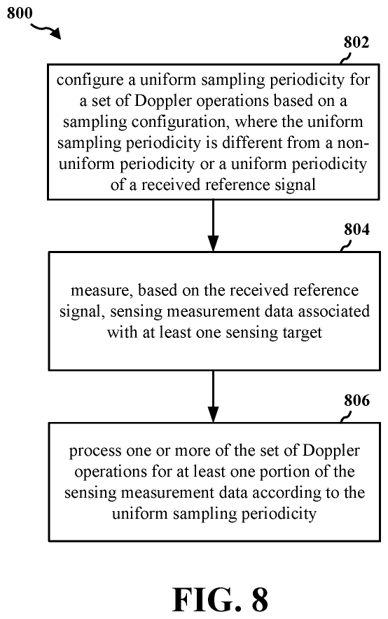

FIG. 8 is a flowchart 800 of a method of wireless communication, in various aspects. The method may be performed by a sensing node (e.g., the UE 104, 404; the sensing node 602, 702; the TRP 402, 406; the apparatus 1104). In some aspects, the method may include aspects described in connection with the communication flow in FIG. 6 and/or aspects described in FIGS. 5, 7. The method provides for multi-hypothesis measurement configuration in RF sensing for sensing measurements that enable wireless devices, e.g., sensing nodes, and base stations/LMFs, e.g., sensing entities, to improve and maintain sensing measurement performance and efficiency through configuration and utilization of multiple sensing hypotheses.

At 802, a sensing node configures a uniform sampling periodicity for a set of Doppler operations based on a sampling configuration, where the uniform sampling periodicity is different from a non-uniform periodicity or a uniform periodicity of a received reference signal. As an example, the configuring may be performed, at least in part, by the component 198. FIGS. 6, 7, illustrate an example of the sensing node 602 configuring such a uniform sampling periodicity (e.g., autonomously and/or via communications with a sensing entity such as the sensing entity 604).

For example, the sensing node 602 may be configured to obtain a sampling configuration 606. For Doppler processing (e.g., at 614 in FIG. 6; 716, 716-1, 716-2, 716-3 in FIG. 7), the aspects herein provide for a sensing node, e.g., the sensing node 602, to assume uniform sampling (e.g., 712, 722 in FIG. 7) and/or to disregard non-uniform sampling when it exists. For instance, aspects may utilize cases in which any degradation in Doppler processing performed by the sensing node 602 due to non-uniform sampling may be negligible. Thus, a uniform periodicity (e.g., 712, 722 in FIG. 7) may be used for the Doppler processing (e.g., FFT-based) (e.g., at 614 in FIG. 6; 716, 716-1, 716-2, 716-3 in FIG. 7), and may be configured by the sensing entity 704 (or other network entity/node) or by the sensing node 602 itself.

In aspects, the sensing node 602 may be configured to receive, from the sensing entity 604, the sampling configuration 606 prior to the configuration of a uniform sampling periodicity (e.g., 712, 722 in FIG. 7). The sampling configuration 606 may indicate the uniform sampling periodicity (e.g., 712, 722 in FIG. 7) for a set of Doppler operations (e.g., at 614 in FIG. 6; 716, 716-1, 716-2, 716-3 in FIG. 7), e.g., Doppler operations to be performed by the sensing node 602. In aspects, the uniform sampling periodicity (e.g., 712, 722 in FIG. 7) for the set of Doppler operations (e.g., at 614 in FIG. 6; 716, 716-1, 716-2, 716-3 in FIG. 7) may be a first duration of a first slot that includes a symbol with a long CP, a second duration of a second slot that does not include any symbol with the long CP, a third duration of an average slot length, and/or the like (e.g., 505, 508, 510 in FIG. 5; 710, 722 in FIG. 7). In some aspects, the sensing node 602 may be configured to obtain the sampling configuration 606 itself by performing operations to calculate characteristics (e.g., 505, 508, 510 in FIG. 5; 710, 722 in FIG. 7) of the uniform sampling periodicity (e.g., 712, 722 in FIG. 7). For instance, the sampling configuration 606 may be obtained by the sensing node 602 based on a length of the uniform sampling periodicity (e.g., 712, 722 in FIG. 7) or a frequency of the uniform sampling periodicity (e.g., 712, 722 in FIG. 7). In some aspects the sampling configuration 606 may be obtained by the sensing node 602 through selection that may be based on the sampling configuration 606 as stored by the sensing node 602. For example, the sensing node 602 may select the sampling configuration 606 from one or more options in a data structure (e.g., a list or the like) associated with reference signals (e.g., 610 in FIG. 6; 706, 706-1 in FIG. 7) that are received by the sensing node 602. In some aspects, the sampling configuration 606 may include an indication for the sensing node 602 to provide an indication back to the sensing entity 604 for the uniform sampling periodicity (e.g., 712, 722 in FIG. 7) that is configured/utilized.

As one example, for the case where the SCS is 120 kHz, and there are 1-slot periodic PRS resources, the sampling configuration 606 for sensing node 602 may indicate to use T₀=1.2487e-04 s as the sampling period (e.g., for a slot including a symbol with a long CP) or to use T₀=1.2539e-04 s (e.g., the duration of a slot without a symbol having the long CP) (e.g., 505, 508, 510 in FIG. 5; 710, 722 in FIG. 7). In aspects, the sensing entity 604 may indicate in the sampling configuration 606 another value for T₀, e.g., an average of the slot lengths, such as where T₀=1.25e-04 s (e.g., 710, 722 in FIG. 7).

The sensing node 602 may be configured to configure (at 608) a uniform sampling periodicity (e.g., 712, 722 in FIG. 7) for a set of Doppler operations (e.g., at 614 in FIG. 6; 716, 716-1, 716-2, 716-3 in FIG. 7). In aspects, the uniform sampling periodicity (e.g., 712, 722 in FIG. 7) may be based on the sampling configuration 606. The uniform sampling periodicity (e.g., 712, 722 in FIG. 7) that is configured may be different from a non-uniform periodicity or a uniform periodicity of a received reference signal, e.g., a reference signal 610 (e.g., 706, 706-1 in FIG. 7) described below. In aspects, as noted above for the sampling configuration 606, the node 602 may be configured to configure (at 608) the uniform sampling periodicity (e.g., 712, 722 in FIG. 7) by performing operations to calculate characteristics of the uniform sampling periodicity (e.g., 712, 722 in FIG. 7). In aspects for performing such operations, the sensing node 602 may be configured to calculate a length of the uniform sampling periodicity (e.g., 712, 722 in FIG. 7) or a frequency of the uniform sampling periodicity (e.g., 712, 722 in FIG. 7). The sensing node 602 may thus be configured to configure the uniform sampling periodicity (e.g., 712, 722 in FIG. 7) for itself based on the length of the uniform sampling periodicity (e.g., 712, 722 in FIG. 7) and/or the frequency of the uniform sampling periodicity (e.g., 712, 722 in FIG. 7) that is/are calculated.

At 804, a sensing node measures, based on the received reference signal, sensing measurement data associated with at least one sensing target. As an example, the measurement may be performed, at least in part, by the component 198. FIGS. 6, 7, illustrate an example of the sensing node 602 measuring sensing measurement data based on a received reference signal (e.g., provided by the sensing entity 604, another UE, a TRP, and/or the like).

For example, the sensing node 602 may be configured to receive the reference signal 610 (e.g., 706, 706-1 in FIG. 7). The reference signal 610 (e.g., 706, 706-1 in FIG. 7) may be received, and transmitted from the sensing entity 604, another UE, and/or a TRP. The received reference signal 610 (e.g., 706, 706-1 in FIG. 7) may have a uniform periodicity, and each resource (e.g., 720 in FIG. 7) associated with the received reference signal 610 (e.g., 706, 706-1 in FIG. 7) may have a same CP with a uniform CP length. In aspects, the uniform periodicity of the received reference signal 610 (e.g., 706, 706-1 in FIG. 7) may not follow prior protocols or standards. In aspects, the same CP with the uniform CP length may be a NCP and/or an ECP. The received reference signal 610 (e.g., 706, 706-1 in FIG. 7) may be a PRS or a SRS-pos. In such aspects, each resource (e.g., 720 in FIG. 7) associated with the received reference signal 610 (e.g., 706, 706-1 in FIG. 7) may be a dedicated time domain resource or a dedicated frequency domain resource (e.g., 720 in FIG. 7). In aspects, while the extra CP length may be designed to align signals/channels with other signals/channels, not using a long CP may be carried out in some scenarios. For example, if reference signal transmissions (e.g., 706, 706-1 in FIG. 7) occur in a dedicated frequency domain resource or time domain resources (e.g., 720 in FIG. 7) (e.g., a transmission gap), where no other operations are expected, alignment may be unnecessary.

The sensing node 602 may be configured to measure (at 612) sensing measurement data, associated with at least one sensing target, based on the received reference signal 610. For example, the sensing node 602 may measure (at 612) (e.g., 708 in FIG. 7), via RF sensing, characteristics of the received reference signal 610 (e.g., 706, 706-1 in FIG. 7) to obtain the sensing measurement data (e.g., 710, in FIG. 7).

At 806, a sensing node processes one or more of the set of Doppler operations for at least one portion of the sensing measurement data according to the uniform sampling periodicity. As an example, the processing may be performed, at least in part, by the component 198. FIGS. 6, 7, illustrate an example of the sensing node 602 processing a set of Doppler operations.

The sensing node 602 may be configured to process (at 614) one or more of the set of Doppler operations (e.g., 716, 716-1, 716-2, 716-3 in FIG. 7) for at least one portion (e.g., 714, 724 in FIG. 7) of the sensing measurement data (e.g., 710, in FIG. 7) (e.g., based on the sampling configuration 606) according to the uniform sampling periodicity (e.g., 712, 722 in FIG. 7). In aspects, the sensing node 602 may be configured to process (at 614) one or more of the set of Doppler operations (e.g., 716, 716-1, 716-2, 716-3 in FIG. 7) by performing a FFT(s) for at least one portion (e.g., 714, 724 in FIG. 7) of the sensing measurement data (e.g., 710, in FIG. 7).

As one example, a portion (e.g., 714, 724 in FIG. 7) of the sensing measurement data (e.g., 710, in FIG. 7) measured (at 612) may be processed by the sensing node 602 based on a periodic measurement sampling for a sub-sequence of the sensing measurement data (e.g., 710, in FIG. 7), and the sensing node 602 may be configured to process (at 614), via Doppler processing (e.g., 716, 716-1, 716-2, 716-3 in FIG. 7), uniformly periodic measurements through extraction or sampling (e.g., 712, 722 in FIG. 7) of periodic measurement sub-sequences (e.g., 714, 724 in FIG. 7) from the RF sensing measurements (e.g., at 612 in FIG. 6; 712 in FIG. 7). In aspects, a period of the periodic measurement sampling (e.g., 712, 722 in FIG. 7) for the sub-sequence (e.g., 714 in FIG. 7) of the sensing measurement data (e.g., 710, in FIG. 7) may correspond to four slots. In aspects, a sub-sequence may be a sequential set or subset of a sequence, e.g., the sequence of the sensing measurement data (e.g., 710, in FIG. 7), that may be generated based on the periodic measurement sampling (e.g., a less dense set/subset of data obtained by extracting/sampling a datum of the sensing measurement data (e.g., 710, in FIG. 7) at an nth instance(s) of the data).

As another example, to process (at 614), the sensing node 602 may be configured to process two or more of the set of Doppler operations (e.g., 716, 716-1, 716-2, 716-3 in FIG. 7) for at least two portions (e.g., 714, 724 in FIG. 7) of the sensing measurement data (e.g., 710, in FIG. 7) according to the periodic measurement sampling for the sub-sequence of the sensing measurement data (e.g., 710, in FIG. 7) to generate two or more Doppler outputs (e.g., 716, 716-1, 716-2 in FIG. 7), and to calculate an average (e.g., 716, 716-3 in FIG. 7) of the two or more Doppler outputs associated with the two or more of the set of Doppler operations (e.g., 716, 716-1, 716-2 in FIG. 7). For instance, the sensing node 602 may be configured to utilize every fourth measurement via uniform measurement sampling (e.g., 712, 722 in FIG. 7) of the sensing measurement data (e.g., 710, in FIG. 7) to achieve a periodic sequence for a period 4 slots, or 0.5 ms. Additionally, as there may be four possible sub-sequences, each with a different offset, the sensing node 602 may be configured to average the Doppler outputs obtained over each sequence.

The sensing node 602 may be configured to provide/transmit a set of results 616. In aspects, the set of results 616 (e.g., 718 in FIG. 7) may be for a set of results of processing (at 614) one or more of the set of Doppler operations (e.g., 716, 716-1, 716-2, 716-3 in FIG. 7) for the at least one portion of the sensing measurement data (e.g., 710, in FIG. 7). The sensing node 602 may provide/transmit the set of results 616 (e.g., 718 in FIG. 7) to the sensing entity 604.

In aspects, the sensing node 602 may be configured to provide/transmit an indication of the uniform sampling periodicity (e.g., 712, 722 in FIG. 7) configured for the set of Doppler operations (e.g., 716, 716-1, 716-2, 716-3 in FIG. 7). For example, in aspects for which the sensing node 602 configures the uniform sampling periodicity (e.g., 712, 722 in FIG. 7) itself, as described above, the sensing node 602 may report to the sensing entity 604 the uniform sampling periodicity (e.g., 712, 722 in FIG. 7) that was self-configured and/or utilized for the set of Doppler operations (e.g., 716, 716-1, 716-2, 716-3 in FIG. 7) so that the sensing entity 604 may be aware of the configured uniform sampling periodicity (e.g., 712, 722 in FIG. 7). In such aspects, the sensing node 602 may be configured to provide/transmit an indication of the uniform sampling periodicity (e.g., 712, 722 in FIG. 7) configured for the set of Doppler operations (e.g., 716, 716-1, 716-2, 716-3 in FIG. 7) based on the sampling configuration 606.

In aspects, transmitting nodes and/or receiving nodes may be sensing nodes and/or sensing entities, as described herein.

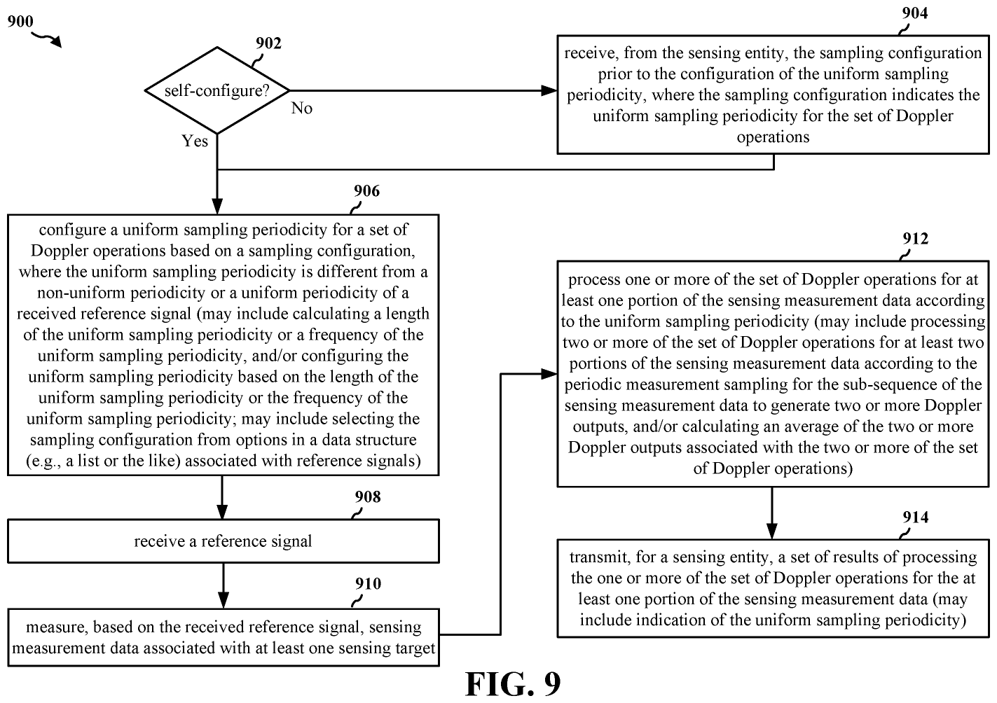

FIG. 9 is a flowchart 900 of a method of wireless communication, in various aspects. The method may be performed by a sensing node (e.g., the UE 104, 404; the sensing node 602, 702; the TRP 402, 406; the apparatus 1104). In some aspects, the method may include aspects described in connection with the communication flow in FIG. 6 and/or aspects described in FIGS. 5, 7. The method provides for multi-hypothesis measurement configuration in RF sensing for sensing measurements that enable wireless devices, e.g., sensing nodes, and base stations/LMFs, e.g., sensing entities, to improve and maintain sensing measurement performance and efficiency through configuration and utilization of multiple sensing hypotheses.

At 902, a sensing node determines if a self-configuration or a received-configuration may be performed for a uniform sampling periodicity. If the sensing node performs a self-configuration, flowchart 900 may continue to 906; if the sensing node receives a configuration from a sensing entity, flowchart 900 may continue to 904. As an example, the configuring may be performed, at least in part, by the component 198. FIGS. 6, 7, illustrate an example of the sensing node 602 configuring such a uniform sampling periodicity (e.g., autonomously and/or via communications with a sensing entity such as the sensing entity 604).

For example, the sensing node 602 may be configured to obtain a sampling configuration 606. For Doppler processing (e.g., at 614 in FIG. 6; 716, 716-1, 716-2, 716-3 in FIG. 7), the aspects herein provide for a sensing node, e.g., the sensing node 602, to assume uniform sampling (e.g., 712, 722 in FIG. 7) and/or to disregard non-uniform sampling when it exists. For instance, aspects may utilize cases in which any degradation in Doppler processing performed by the sensing node 602 due to non-uniform sampling may be negligible. Thus, a uniform periodicity (e.g., 712, 722 in FIG. 7) may be used for the Doppler processing (e.g., FFT-based) (e.g., at 614 in FIG. 6; 716, 716-1, 716-2, 716-3 in FIG. 7), and may be configured by the sensing entity 704 (or other network entity/node) or by the sensing node 602 itself.

In some aspects, the sensing node 602 may be configured to obtain the sampling configuration 606 itself by performing operations to calculate characteristics (e.g., 505, 508, 510 in FIG. 5; 710, 722 in FIG. 7) of the uniform sampling periodicity (e.g., 712, 722 in FIG. 7). For instance, the sampling configuration 606 may be obtained by the sensing node 602 based on a length of the uniform sampling periodicity (e.g., 712, 722 in FIG. 7) or a frequency of the uniform sampling periodicity (e.g., 712, 722 in FIG. 7). In some aspects the sampling configuration 606 may be obtained by the sensing node 602 through selection that may be based on the sampling configuration 606 as stored by the sensing node 602. For example, the sensing node 602 may select the sampling configuration 606 from one or more options in data structure (e.g., a list or the like) associated with reference signals (e.g., 610 in FIG. 6; 706, 706-1 in FIG. 7) that are received by the sensing node 602.

In some aspects, the sampling configuration 606 may include an indication for the sensing node 602 to provide an indication back to the sensing entity 604 for the uniform sampling periodicity (e.g., 712, 722 in FIG. 7) that is configured/utilized.

As one example, for the case where the SCS is 120 kHz, and there are 1-slot periodic PRS resources, the sampling configuration 606 for sensing node 602 may indicate to use T₀=1.2487e-04 s as the sampling period (e.g., for a slot including a symbol with a long CP) or to use T₀=1.2539e-04 s (e.g., the duration of a slot without a symbol having the long CP) (e.g., 505, 508, 510 in FIG. 5; 710, 722 in FIG. 7). In aspects, the sensing entity 604 may indicate in the sampling configuration 606 another value for T₀, e.g., an average of the slot lengths, such as where T₀=1.25e-04 s (e.g., 710, 722 in FIG. 7).

At 904, a sensing node receives, from the sensing entity, the sampling configuration prior to the configuration of the uniform sampling periodicity, where the sampling configuration indicates the uniform sampling periodicity for the set of Doppler operations. As an example, the configuring may be performed, at least in part, by the component 198. FIGS. 6, 7, illustrate an example of the sensing node 602 configuring such a uniform sampling periodicity (e.g., autonomously and/or via communications with a sensing entity such as the sensing entity 604).

In aspects, the sensing node 602 may be configured to receive, from the sensing entity 604, the sampling configuration 606 prior to the configuration of a uniform sampling periodicity (e.g., 712, 722 in FIG. 7). The sampling configuration 606 may indicate the uniform sampling periodicity (e.g., 712, 722 in FIG. 7) for a set of Doppler operations (e.g., at 614 in FIG. 6; 716, 716-1, 716-2, 716-3 in FIG. 7), e.g., Doppler operations to be performed by the sensing node 602. In aspects, the uniform sampling periodicity (e.g., 712, 722 in FIG. 7) for the set of Doppler operations (e.g., at 614 in FIG. 6; 716, 716-1, 716-2, 716-3 in FIG. 7) may be a first duration of a first slot that includes a symbol with a long CP, a second duration of a second slot that does not include any symbol with the long CP, a third duration of an average slot length, and/or the like (e.g., 505, 508, 510 in FIG. 5; 710, 722 in FIG. 7).

At 906, a sensing node configures a uniform sampling periodicity for a set of Doppler operations based on a sampling configuration, where the uniform sampling periodicity is different from a non-uniform periodicity or a uniform periodicity of a received reference signal. As an example, the configuring may be performed, at least in part, by the component 198. FIGS. 6, 7, illustrate an example of the sensing node 602 configuring such a uniform sampling periodicity (e.g., autonomously and/or via communications with a sensing entity such as the sensing entity 604).

The sensing node 602 may be configured to configure (at 608) a uniform sampling periodicity (e.g., 712, 722 in FIG. 7) for a set of Doppler operations (e.g., at 614 in FIG. 6; 716, 716-1, 716-2, 716-3 in FIG. 7). In aspects, the uniform sampling periodicity (e.g., 712, 722 in FIG. 7) may be based on the sampling configuration 606. The uniform sampling periodicity (e.g., 712, 722 in FIG. 7) that is configured may be different from a non-uniform periodicity or a uniform periodicity of a received reference signal, e.g., a reference signal 610 (e.g., 706, 706-1 in FIG. 7) described below. In aspects, as noted above for the sampling configuration 606, the node 602 may be configured to configure (at 608) the uniform sampling periodicity (e.g., 712, 722 in FIG. 7) by performing operations to calculate characteristics of the uniform sampling periodicity (e.g., 712, 722 in FIG. 7). In aspects for performing such operations, the sensing node 602 may be configured to calculate a length of the uniform sampling periodicity (e.g., 712, 722 in FIG. 7) or a frequency of the uniform sampling periodicity (e.g., 712, 722 in FIG. 7). The sensing node 602 may thus be configured to configure the uniform sampling periodicity (e.g., 712, 722 in FIG. 7) for itself based on the length of the uniform sampling periodicity (e.g., 712, 722 in FIG. 7) and/or the frequency of the uniform sampling periodicity (e.g., 712, 722 in FIG. 7) that is/are calculated.

At 908, a sensing node receives a reference signal. As an example, the reception may be performed, at least in part, by the component 198. FIGS. 6, 7, illustrate an example of the sensing node 602 receiving a received reference signal (e.g., provided by the sensing entity 604, another UE, a TRP, and/or the like).

For example, the sensing node 602 may be configured to receive the reference signal 610 (e.g., 706, 706-1 in FIG. 7). The reference signal 610 (e.g., 706, 706-1 in FIG. 7) may be received, and transmitted from the sensing entity 604, another UE, and/or a TRP. The received reference signal 610 (e.g., 706, 706-1 in FIG. 7) may have a uniform periodicity, and each resource (e.g., 720 in FIG. 7) associated with the received reference signal 610 (e.g., 706, 706-1 in FIG. 7) may have a same CP with a uniform CP length. In aspects, the uniform periodicity of the received reference signal 610 (e.g., 706, 706-1 in FIG. 7) may not follow prior protocols or standards. In aspects, the same CP with the uniform CP length may be a NCP and/or an ECP. The received reference signal 610 (e.g., 706, 706-1 in FIG. 7) may be a PRS or a SRS-pos. In such aspects, each resource (e.g., 720 in FIG. 7) associated with the received reference signal 610 (e.g., 706, 706-1 in FIG. 7) may be a dedicated time domain resource or a dedicated frequency domain resource (e.g., 720 in FIG. 7). In aspects, while the extra CP length may be designed to align signals/channels with other signals/channels, not using a long CP may be carried out in some scenarios. For example, if reference signal transmissions (e.g., 706, 706-1 in FIG. 7) occur in a dedicated frequency domain resource or time domain resources (e.g., 720 in FIG. 7) (e.g., a transmission gap), where no other operations are expected, alignment may be unnecessary.

At 910, a sensing node measures, based on the received reference signal, sensing measurement data associated with at least one sensing target. As an example, the measurement may be performed, at least in part, by the component 198. FIGS. 6, 7, illustrate an example of the sensing node 602 measuring sensing measurement data based on a received reference signal (e.g., provided by the sensing entity 604, another UE, a TRP, and/or the like).

The sensing node 602 may be configured to measure (at 612) sensing measurement data, associated with at least one sensing target, based on the received reference signal 610. For example, the sensing node 602 may measure (at 612) (e.g., 708 in FIG. 7), via RF sensing, characteristics of the received reference signal 610 (e.g., 706, 706-1 in FIG. 7) to obtain the sensing measurement data (e.g., 710, in FIG. 7).

At 912, a sensing node processes one or more of the set of Doppler operations for at least one portion of the sensing measurement data according to the uniform sampling periodicity. As an example, the processing may be performed, at least in part, by the component 198. FIGS. 6, 7, illustrate an example of the sensing node 602 processing a set of Doppler operations.

The sensing node 602 may be configured to process (at 614) one or more of the set of Doppler operations (e.g., 716, 716-1, 716-2, 716-3 in FIG. 7) for at least one portion (e.g., 714, 724 in FIG. 7) of the sensing measurement data (e.g., 710, in FIG. 7) (e.g., based on the sampling configuration 606) according to the uniform sampling periodicity (e.g., 712, 722 in FIG. 7). In aspects, the sensing node 602 may be configured to process (at 614) one or more of the set of Doppler operations (e.g., 716, 716-1, 716-2, 716-3 in FIG. 7) by performing a FFT(s) for at least one portion (e.g., 714, 724 in FIG. 7) of the sensing measurement data (e.g., 710, in FIG. 7).

As one example, a portion (e.g., 714, 724 in FIG. 7) of the sensing measurement data (e.g., 710, in FIG. 7) measured (at 612) may be processed by the sensing node 602 based on a periodic measurement sampling for a sub-sequence of the sensing measurement data (e.g., 710, in FIG. 7), and the sensing node 602 may be configured to process (at 614), via Doppler processing (e.g., 716, 716-1, 716-2, 716-3 in FIG. 7), uniformly periodic measurements through extraction or sampling (e.g., 712, 722 in FIG. 7) of periodic measurement sub-sequences (e.g., 714, 724 in FIG. 7) from the RF sensing measurements (e.g., at 612 in FIG. 6; 712 in FIG. 7). In aspects, a period of the periodic measurement sampling (e.g., 712, 722 in FIG. 7) for the sub-sequence (e.g., 714 in FIG. 7) of the sensing measurement data (e.g., 710, in FIG. 7) may correspond to four slots. In aspects, a sub-sequence may be a sequential set or subset of a sequence, e.g., the sequence of the sensing measurement data (e.g., 710, in FIG. 7), that may be generated based on the periodic measurement sampling (e.g., a less dense set/subset of data obtained by extracting/sampling a datum of the sensing measurement data (e.g., 710, in FIG. 7) at an nth instance(s) of the data).

As another example, to process (at 614), the sensing node 602 may be configured to process two or more of the set of Doppler operations (e.g., 716, 716-1, 716-2, 716-3 in FIG. 7) for at least two portions (e.g., 714, 724 in FIG. 7) of the sensing measurement data (e.g., 710, in FIG. 7) according to the periodic measurement sampling for the sub-sequence of the sensing measurement data (e.g., 710, in FIG. 7) to generate two or more Doppler outputs (e.g., 716, 716-1, 716-2 in FIG. 7), and to calculate an average (e.g., 716, 716-3 in FIG. 7) of the two or more Doppler outputs associated with the two or more of the set of Doppler operations (e.g., 716, 716-1, 716-2 in FIG. 7). For instance, the sensing node 602 may be configured to utilize every fourth measurement via uniform measurement sampling (e.g., 712, 722 in FIG. 7) of the sensing measurement data (e.g., 710, in FIG. 7) to achieve a periodic sequence for a period 4 slots, or 0.5 ms. Additionally, as there may be four possible sub-sequences, each with a different offset, the sensing node 602 may be configured to average the Doppler outputs obtained over each sequence.

At 914, sending node transmits/provides, for a sensing entity, a set of results of processing the one or more of the set of Doppler operations for the at least one portion of the sensing measurement data. As an example, the transmitting/providing may be performed, at least in part, by the component 198. FIGS. 6, 7, illustrate an example of the sensing node 602 transmitting a set of Doppler operations.

The sensing node 602 may be configured to provide/transmit a set of results 616. In aspects, the set of results 616 (e.g., 718 in FIG. 7) may be for a set of results of processing (at 614) one or more of the set of Doppler operations (e.g., 716, 716-1, 716-2, 716-3 in FIG. 7) for the at least one portion of the sensing measurement data (e.g., 710, in FIG. 7). The sensing node 602 may provide/transmit the set of results 616 (e.g., 718 in FIG. 7) to the sensing entity 604.

In aspects, the sensing node 602 may be configured to provide/transmit an indication of the uniform sampling periodicity (e.g., 712, 722 in FIG. 7) configured for the set of Doppler operations (e.g., 716, 716-1, 716-2, 716-3 in FIG. 7). For example, in aspects for which the sensing node 602 configures the uniform sampling periodicity (e.g., 712, 722 in FIG. 7) itself, as described above, the sensing node 602 may report to the sensing entity 604 the uniform sampling periodicity (e.g., 712, 722 in FIG. 7) that was self-configured and/or utilized for the set of Doppler operations (e.g., 716, 716-1, 716-2, 716-3 in FIG. 7) so that the sensing entity 604 may be aware of the configured uniform sampling periodicity (e.g., 712, 722 in FIG. 7). In such aspects, the sensing node 602 may be configured to provide/transmit an indication of the uniform sampling periodicity (e.g., 712, 722 in FIG. 7) configured for the set of Doppler operations (e.g., 716, 716-1, 716-2, 716-3 in FIG. 7) based on the sampling configuration 606.

In aspects, transmitting nodes and/or receiving nodes may be sensing nodes and/or sensing entities, as described herein.

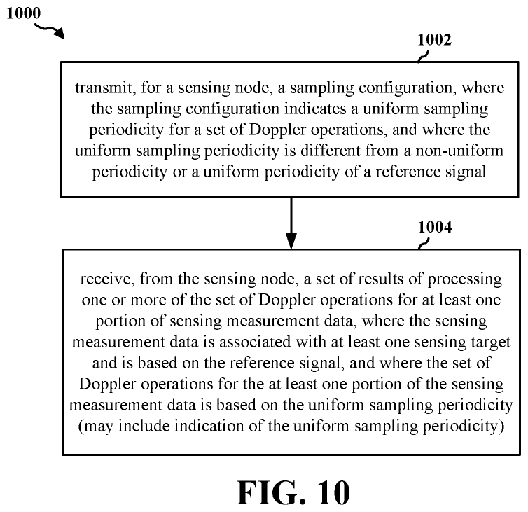

FIG. 10 is a flowchart 1000 of a method of wireless communication, in various aspects. The method may be performed by a sensing entity, such as an LMF or a base station/network node (e.g., the base station 102; the LMF 166; the sensing entity 604, 704; the network entity 1102, 1202, 1360). In some aspects, the method may include aspects described in connection with the communication flow in FIG. 6 and/or aspects described in FIGS. 5, 7. The method provides for multi-hypothesis measurement configuration in RF sensing for sensing measurements that enable wireless devices, e.g., sensing nodes, and base stations/LMFs, e.g., sensing entities, to improve and maintain sensing measurement performance and efficiency through configuration and utilization of multiple sensing hypotheses.

At 1002, a sensing node transmits, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. As an example, the reception may be performed, at least in part, by the component 199. FIGS. 6-9 illustrate an example of the sensing entity 604 transmitting such a configuration for a sensing node (e.g., sensing node 602).

For example, the sensing node 602 may be configured to obtain a sampling configuration 606. For Doppler processing (e.g., at 614 in FIG. 6; 716, 716-1, 716-2, 716-3 in FIG. 7), the aspects herein provide for a sensing node, e.g., the sensing node 602, to assume uniform sampling (e.g., 712, 722 in FIG. 7) and/or to disregard non-uniform sampling when it exists. For instance, aspects may utilize cases in which any degradation in Doppler processing performed by the sensing node 602 due to non-uniform sampling may be negligible. Thus, a uniform periodicity (e.g., 712, 722 in FIG. 7) may be used for the Doppler processing (e.g., FFT-based) (e.g., at 614 in FIG. 6; 716, 716-1, 716-2, 716-3 in FIG. 7), and may be configured by the sensing entity 704 (or other network entity/node) or by the sensing node 602 itself.

In aspects, the sensing node 602 may be configured to receive, as transmitted/provided by the sensing entity 604, the sampling configuration 606 prior to the configuration of a uniform sampling periodicity (e.g., 712, 722 in FIG. 7). The sampling configuration 606 may indicate the uniform sampling periodicity (e.g., 712, 722 in FIG. 7) for a set of Doppler operations (e.g., at 614 in FIG. 6; 716, 716-1, 716-2, 716-3 in FIG. 7), e.g., Doppler operations to be performed by the sensing node 602. In aspects, the uniform sampling periodicity (e.g., 712, 722 in FIG. 7) for the set of Doppler operations (e.g., at 614 in FIG. 6; 716, 716-1, 716-2, 716-3 in FIG. 7) may be a first duration of a first slot that includes a symbol with a long CP, a second duration of a second slot that does not include any symbol with the long CP, a third duration of an average slot length, and/or the like (e.g., 505, 508, 510 in FIG. 5; 710, 722 in FIG. 7). In some aspects, the sampling configuration 606 may include an indication for the sensing node 602 to provide an indication back to the sensing entity 604 for the uniform sampling periodicity (e.g., 712, 722 in FIG. 7) that is configured/utilized.

At 1004, the sensing entity receives, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity. As an example, the reception may be performed, at least in part, by the component 199. FIGS. 6-9 illustrate an example of the sensing entity 604 receiving such a set of results of Doppler operations from a sensing node (e.g., sensing node 602).

The sensing entity 604 may be configured to receive a set of results 616 provided/transmitted from the sensing node 602. In aspects, the set of results 616 (e.g., 718 in FIG. 7) may be for a set of results of processing (at 614) one or more of the set of Doppler operations (e.g., 716, 716-1, 716-2, 716-3 in FIG. 7) for the at least one portion of the sensing measurement data (e.g., 710, in FIG. 7). The sensing node 602 may provide/transmit the set of results 616 (e.g., 718 in FIG. 7) to the sensing entity 604.

As described, sensing node 602 may be configured to configure (at 608) a uniform sampling periodicity (e.g., 712, 722 in FIG. 7) for a set of Doppler operations (e.g., at 614 in FIG. 6; 716, 716-1, 716-2, 716-3 in FIG. 7). In aspects, the uniform sampling periodicity (e.g., 712, 722 in FIG. 7) may be based on the sampling configuration 606. The uniform sampling periodicity (e.g., 712, 722 in FIG. 7) that is configured may be different from a non-uniform periodicity or a uniform periodicity of a received reference signal, e.g., a reference signal 610 (e.g., 706, 706-1 in FIG. 7) described below. In aspects, as noted above for the sampling configuration 606, the node 602 may be configured to configure (at 608) the uniform sampling periodicity (e.g., 712, 722 in FIG. 7) by performing operations to calculate characteristics of the uniform sampling periodicity (e.g., 712, 722 in FIG. 7). In aspects for performing such operations, the sensing node 602 may be configured to calculate a length of the uniform sampling periodicity (e.g., 712, 722 in FIG. 7) or a frequency of the uniform sampling periodicity (e.g., 712, 722 in FIG. 7). The sensing node 602 may thus be configured to configure the uniform sampling periodicity (e.g., 712, 722 in FIG. 7) for itself based on the length of the uniform sampling periodicity (e.g., 712, 722 in FIG. 7) and/or the frequency of the uniform sampling periodicity (e.g., 712, 722 in FIG. 7) that is/are calculated. The sensing node 602 may also be configured to receive the reference signal 610 (e.g., 706, 706-1 in FIG. 7). The reference signal 610 (e.g., 706, 706-1 in FIG. 7) may be received, and transmitted from the sensing entity 604, another UE, and/or a TRP. The received reference signal 610 (e.g., 706, 706-1 in FIG. 7) may have a uniform periodicity, and each resource (e.g., 720 in FIG. 7) associated with the received reference signal 610 (e.g., 706, 706-1 in FIG. 7) may have a same CP with a uniform CP length. In aspects, the uniform periodicity of the received reference signal 610 (e.g., 706, 706-1 in FIG. 7) may not follow prior protocols or standards. In aspects, the same CP with the uniform CP length may be a NCP and/or an ECP. The received reference signal 610 (e.g., 706, 706-1 in FIG. 7) may be a PRS or a SRS-pos. In such aspects, each resource (e.g., 720 in FIG. 7) associated with the received reference signal 610 (e.g., 706, 706-1 in FIG. 7) may be a dedicated time domain resource or a dedicated frequency domain resource (e.g., 720 in FIG. 7). In aspects, while the extra CP length may be designed to align signals/channels with other signals/channels, not using a long CP may be carried out in some scenarios. For example, if reference signal transmissions (e.g., 706, 706-1 in FIG. 7) occur in a dedicated frequency domain resource or time domain resources (e.g., 720 in FIG. 7) (e.g., a transmission gap), where no other operations are expected, alignment may be unnecessary. The sensing node 602 may be configured to measure (at 612) sensing measurement data, associated with at least one sensing target, based on the received reference signal 610. For example, the sensing node 602 may measure (at 612) (e.g., 708 in FIG. 7), via RF sensing, characteristics of the received reference signal 610 (e.g., 706, 706-1 in FIG. 7) to obtain the sensing measurement data (e.g., 710, in FIG. 7). The sensing node 602 may be configured to process (at 614) one or more of the set of Doppler operations (e.g., 716, 716-1, 716-2, 716-3 in FIG. 7) for at least one portion (e.g., 714, 724 in FIG. 7) of the sensing measurement data (e.g., 710, in FIG. 7) (e.g., based on the sampling configuration 606) according to the uniform sampling periodicity (e.g., 712, 722 in FIG. 7). In aspects, the sensing node 602 may be configured to process (at 614) one or more of the set of Doppler operations (e.g., 716, 716-1, 716-2, 716-3 in FIG. 7) by performing a FFT(s) for at least one portion (e.g., 714, 724 in FIG. 7) of the sensing measurement data (e.g., 710, in FIG. 7).

As one example, a portion (e.g., 714, 724 in FIG. 7) of the sensing measurement data (e.g., 710, in FIG. 7) measured (at 612) may be processed by the sensing node 602 based on a periodic measurement sampling for a sub-sequence of the sensing measurement data (e.g., 710, in FIG. 7), and the sensing node 602 may be configured to process (at 614), via Doppler processing (e.g., 716, 716-1, 716-2, 716-3 in FIG. 7), uniformly periodic measurements through extraction or sampling (e.g., 712, 722 in FIG. 7) of periodic measurement sub-sequences (e.g., 714, 724 in FIG. 7) from the RF sensing measurements (e.g., at 612 in FIG. 6; 712 in FIG. 7). In aspects, a period of the periodic measurement sampling (e.g., 712, 722 in FIG. 7) for the sub-sequence (e.g., 714 in FIG. 7) of the sensing measurement data (e.g., 710, in FIG. 7) may correspond to four slots. In aspects, a sub-sequence may be a sequential set or subset of a sequence, e.g., the sequence of the sensing measurement data (e.g., 710, in FIG. 7), that may be generated based on the periodic measurement sampling (e.g., a less dense set/subset of data obtained by extracting/sampling a datum of the sensing measurement data (e.g., 710, in FIG. 7) at an nth instance(s) of the data). As another example, to process (at 614), the sensing node 602 may be configured to process two or more of the set of Doppler operations (e.g., 716, 716-1, 716-2, 716-3 in FIG. 7) for at least two portions (e.g., 714, 724 in FIG. 7) of the sensing measurement data (e.g., 710, in FIG. 7) according to the periodic measurement sampling for the sub-sequence of the sensing measurement data (e.g., 710, in FIG. 7) to generate two or more Doppler outputs (e.g., 716, 716-1, 716-2 in FIG. 7), and to calculate an average (e.g., 716, 716-3 in FIG. 7) of the two or more Doppler outputs associated with the two or more of the set of Doppler operations (e.g., 716, 716-1, 716-2 in FIG. 7). For instance, the sensing node 602 may be configured to utilize every fourth measurement via uniform measurement sampling (e.g., 712, 722 in FIG. 7) of the sensing measurement data (e.g., 710, in FIG. 7) to achieve a periodic sequence for a period 4 slots, or 0.5 ms. Additionally, as there may be four possible sub-sequences, each with a different offset, the sensing node 602 may be configured to average the Doppler outputs obtained over each sequence.

In aspects, the sensing entity 604 may be configured to receive an indication of the uniform sampling periodicity (e.g., 712, 722 in FIG. 7) configured for the set of Doppler operations (e.g., 716, 716-1, 716-2, 716-3 in FIG. 7) provided/transmitted from the sensing node 602. For example, in aspects for which the sensing node 602 configures the uniform sampling periodicity (e.g., 712, 722 in FIG. 7) itself, as described above, the sensing node 602 may report to the sensing entity 604 the uniform sampling periodicity (e.g., 712, 722 in FIG. 7) that was self-configured and/or utilized for the set of Doppler operations (e.g., 716, 716-1, 716-2, 716-3 in FIG. 7) so that the sensing entity 604 may be aware of the configured uniform sampling periodicity (e.g., 712, 722 in FIG. 7). In such aspects, the sensing node 602 may be configured to provide/transmit, received by the sensing entity 604, an indication of the uniform sampling periodicity (e.g., 712, 722 in FIG. 7) configured for the set of Doppler operations (e.g., 716, 716-1, 716-2, 716-3 in FIG. 7) based on the sampling configuration 606.

In aspects, transmitting nodes and/or receiving nodes may be sensing nodes and/or sensing entities, as described herein.

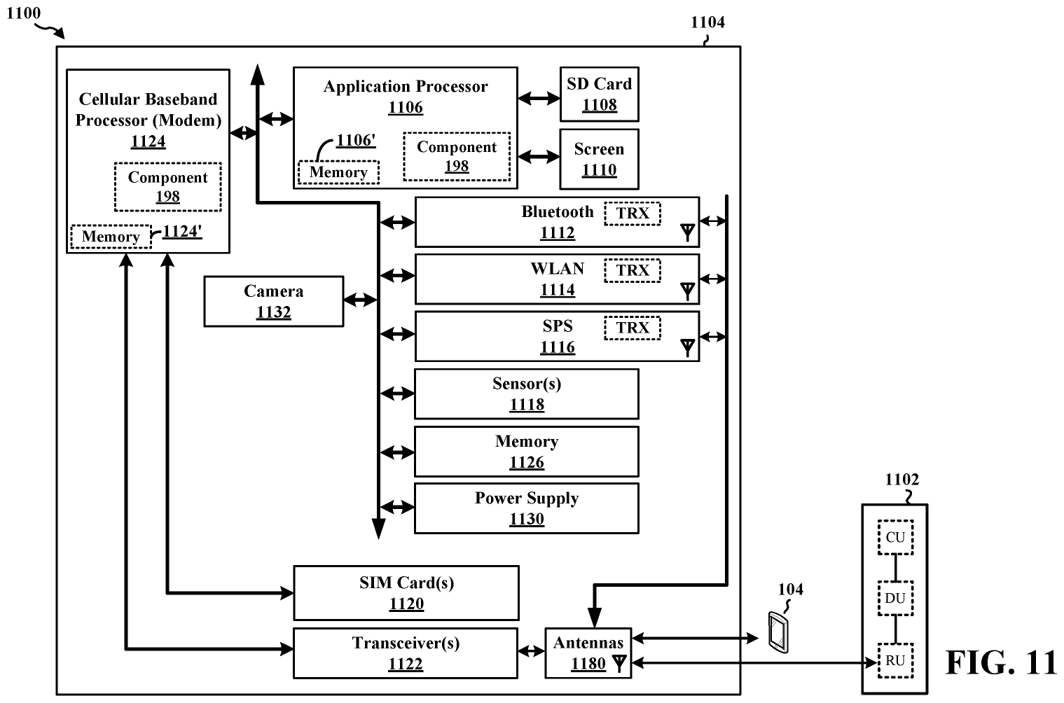

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to configure a uniform sampling periodicity for a set of Doppler operations based on a sampling configuration, where the uniform sampling periodicity is different from a non-uniform periodicity or a uniform periodicity of a received reference signal. The component 198 may also be configured to measure, based on the received reference signal, sensing measurement data associated with at least one sensing target. The component 198 may further be configured to process one or more of the set of Doppler operations for at least one portion of the sensing measurement data according to the uniform sampling periodicity. The component 198 may be configured to transmit, for a sensing entity, a set of results of processing the one or more of the set of Doppler operations for the at least one portion of the sensing measurement data. The component 198 may be configured to receive, from the sensing entity, the sampling configuration prior to the configuration of the uniform sampling periodicity, where the sampling configuration indicates the uniform sampling periodicity for the set of Doppler operations. The component 198 may be further configured to perform any of the aspects described in connection with the flowcharts in any of FIGS. 8-10, and/or any of the aspects performed by a sensing entity for any of FIGS. 5-7. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for configuring a uniform sampling periodicity for a set of Doppler operations based on a sampling configuration, where the uniform sampling periodicity is different from a non-uniform periodicity or a uniform periodicity of a received reference signal. In the configuration, the apparatus 1104, and in particular the cellular baseband processor 1124 and/or the application processor 1106, may include means for measuring, based on the received reference signal, sensing measurement data associated with at least one sensing target. In the configuration, the apparatus 1104, and in particular the cellular baseband processor 1124 and/or the application processor 1106, may include means for processing one or more of the set of Doppler operations for at least one portion of the sensing measurement data according to the uniform sampling periodicity. In one configuration, the apparatus 1104, and in particular the cellular baseband processor 1124 and/or the application processor 1106, may include means for transmitting, for a sensing entity, a set of results of processing the one or more of the set of Doppler operations for the at least one portion of the sensing measurement data. In one configuration, the apparatus 1104, and in particular the cellular baseband processor 1124 and/or the application processor 1106, may include means for receiving, from the sensing entity, the sampling configuration prior to the configuration of the uniform sampling periodicity, where the sampling configuration indicates the uniform sampling periodicity for the set of Doppler operations. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

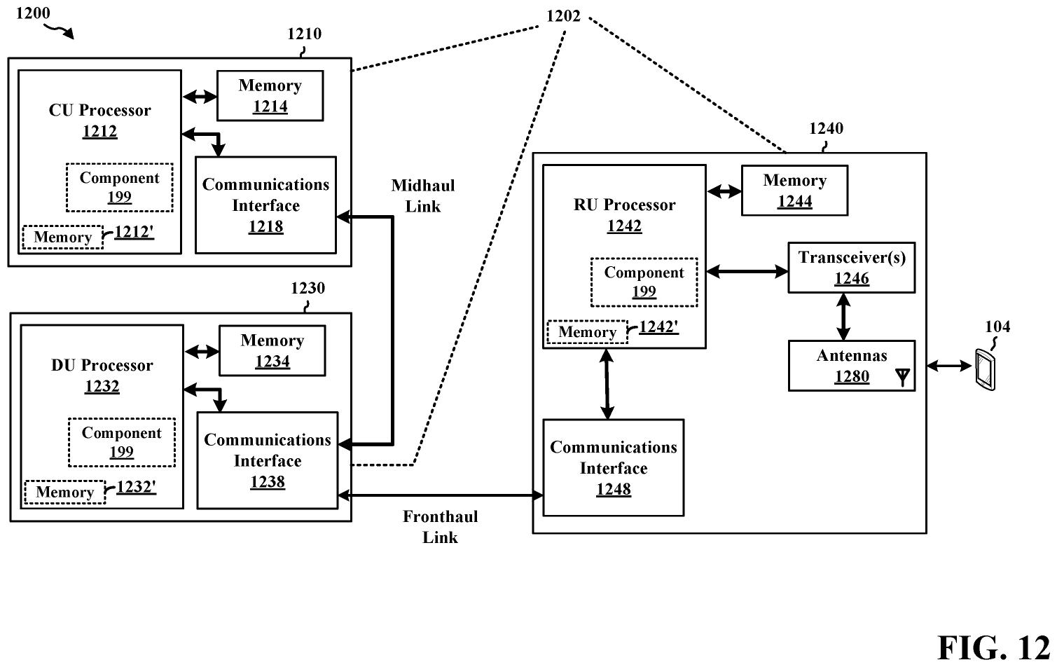

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′. 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The component 199 may also be configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity. The component 199 may be further configured to perform any of the aspects described in connection with the flowcharts in any of FIGS. 8-10, and/or any of the aspects performed by a sensing entity for any of FIGS. 5-7. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for transmitting, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. In the configuration, the network entity 1202 may include means for receiving, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

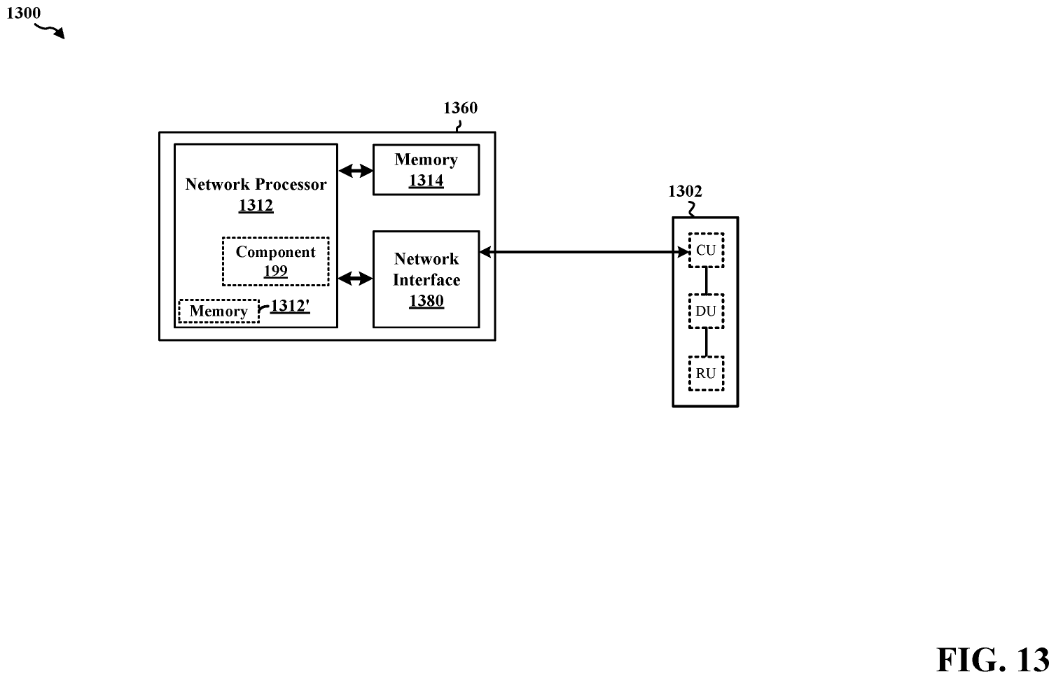

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The component 199 may also be configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity. The component 199 may be further configured to perform any of the aspects described in connection with the flowcharts in any of FIGS. 8-10, and/or any of the aspects performed by a sensing entity for any of FIGS. 5-7. The component 199 may be within the processor 1312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 may include means for transmitting, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. In the configuration, the network entity 1360 may include means for receiving, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity. The means may be the component 199 of the network entity 1360 configured to perform the functions recited by the means.

Wireless communication networks, such as a 5G NR network, may enable sensing measurements and operations for wireless devices. For example, a wireless communication network and/or a wireless device may utilize specific waveforms for communications (e.g., OFDM) and sensing (e.g., RF). RF sensing operations may include scanning an area by sweeping across one or more beams. RF waveforms may be utilized for JCS, environment scanning, object detection, weather monitoring, and/or the like. The use of RF waveforms for sensing may provide for low cost, allow flexibility, and allow the re-use of sensing waveforms for multiple purposes. Wireless communication networks may support and enable sensing and collection of sensing measurement data, NR-based sensing measurement data for processing (e.g., Doppler processing), processing sensing measurement data and associating the sensing measurement data with other assisted information (e.g., location information), exposing sensing measurement data via a core network, etc. However, computational complexities associated with some algorithms, e.g., super-resolution algorithms may hinder performance of operations, or the ability to perform the operations. Such complexities may be prohibitive for UE-based processing, including but not limited to, real-time, or near real-time, applications. Further, Doppler processing may utilize FFTs, and FFT-based processing may assume that the signal to be processed is sampled uniformly in time or in frequency in the case of range processing. Yet, the slot structure in NR may prohibit guarantees of uniform sampling in the time domain of reference signals in some scenarios.

The described aspects for sensing operations, e.g., for Doppler processing in RF sensing for wireless/cellular systems, enable wireless and network devices to more simply and efficiently perform Doppler processing on RF measurements. In one example, a sensing node may be configured to configure a uniform sampling periodicity for a set of Doppler operations based on a sampling configuration, where the uniform sampling periodicity is different from a non-uniform periodicity or a uniform periodicity of a received reference signal. The sensing node may also be configured to measure, based on the received reference signal, sensing measurement data associated with at least one sensing target. The sensing node may further be configured to process one or more of the set of Doppler operations for at least one portion of the sensing measurement data according to the uniform sampling periodicity. In another example, the sensing node may be configured to transmit, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal. The sensing node may also be configured to receive, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity.

Aspects herein enable simplified and more efficient performance of Doppler operations for RF sensing, including FFTs, at sensing nodes are enabled by configuring sensing nodes, such as UEs/TRPs, with a uniform sampling periodicity for Doppler operations. Aspects also enable perform Doppler processing on periodic measurements through extraction (e.g., sampling) of periodic measurement sub-sequences from RF measurements. Aspects further enable provision/transmission of periodic reference signals that have the same CP in all associated resources by configuring reference signals without extra CP lengths.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: configuring a uniform sampling periodicity for a set of Doppler operations based on a sampling configuration, where the uniform sampling periodicity is different from a non-uniform periodicity or a uniform periodicity of a received reference signal; measuring, based on the received reference signal, sensing measurement data associated with at least one sensing target; and processing one or more of the set of Doppler operations for at least one portion of the sensing measurement data according to the uniform sampling periodicity.

Aspect 2 is the method of aspect 1, where the at least one portion of the sensing measurement data is based on a periodic measurement sampling for a sub-sequence of the sensing measurement data.

Aspect 3 is the method of aspect 2, where processing the one or more of the set of Doppler operations for the at least one portion of the sensing measurement data includes: processing two or more of the set of Doppler operations for at least two portions of the sensing measurement data according to the periodic measurement sampling for the sub-sequence of the sensing measurement data to generate two or more Doppler outputs, and calculating an average of the two or more Doppler outputs associated with the two or more of the set of Doppler operations.

Aspect 4 is the method of aspect 3 where a period of the periodic measurement sampling for the sub-sequence of the sensing measurement data corresponds to four slots.

Aspect 5 is the method of any of aspects 1 to 4, where the sensing node is at least one of a user equipment (UE) or a transmission-reception point (TRP).

Aspect 6 is the method of any of aspects 1 to 5, where configuring the uniform sampling periodicity for the set of Doppler operations based on the sampling configuration includes: calculating a length of the uniform sampling periodicity or a frequency of the uniform sampling periodicity; and configuring the uniform sampling periodicity based on the length of the uniform sampling periodicity or the frequency of the uniform sampling periodicity.

Aspect 7 is the method of any of aspects 1 to 6, further including: transmitting, for a sensing entity, at least one of: a set of results of processing the one or more of the set of Doppler operations for the at least one portion of the sensing measurement data; or an indication of the uniform sampling periodicity configured for the set of Doppler operations.

Aspect 8 is the method of aspect 7, where the sensing entity is at least one of a network node or a network entity.

Aspect 9 is the method of aspect 8, where the uniform sampling periodicity for the set of Doppler operations is at least one of a first duration of a first slot that includes a symbol with a long cyclic prefix (CP), a second duration of a second slot that does not include any symbol with the long CP, or a third duration of an average slot length.

Aspect 10 is the method of any of aspects 1 to 5 and 7 to 9, further including: receiving, from the sensing entity, the sampling configuration prior to the configuration of the uniform sampling periodicity, where the sampling configuration indicates the uniform sampling periodicity for the set of Doppler operations.

Aspect 11 is the method of any of aspects 1 to 10, where the received reference signal has the uniform periodicity and each resource associated with the received reference signal has a same cyclic prefix (CP) with a uniform CP length, where the same CP with the uniform CP length is at least one of a normal CP (NCP) or an extended CP (ECP).

Aspect 12 is the method of aspect 11, where the received reference signal is at least one of a positioning reference signal (PRS) or a sounding reference signal (SRS) for positioning (SRS-pos), and where each resource associated with the received reference signal is a dedicated time domain resource or a dedicated frequency domain resource.

Aspect 13 is a method of wireless communications at a sensing entity, including: transmitting, for a sensing node, a sampling configuration, where the sampling configuration indicates a uniform sampling periodicity for a set of Doppler operations, and where the uniform sampling periodicity is different from a non-uniform periodicity or a uniform periodicity of a reference signal; and receiving, from the sensing node, a set of results of processing one or more of the set of Doppler operations for at least one portion of sensing measurement data, where the sensing measurement data is associated with at least one sensing target and is based on the reference signal, and where the set of Doppler operations for the at least one portion of the sensing measurement data is based on the uniform sampling periodicity.

Aspect 14 is the method of aspect 13, where the at least one portion of the sensing measurement data is based on a periodic measurement sampling for a sub-sequence of the sensing measurement data.

Aspect 15 is the method of aspect 14, where the set of results of processing the one or more of the set of Doppler operations for the at least one portion of the sensing measurement data includes an average of two or more Doppler outputs associated with two or more of the set of Doppler operations, where the two or more of the set of Doppler operations are associated with at least two portions of the sensing measurement data according to the periodic measurement sampling for the sub-sequence of the sensing measurement data.

Aspect 16 is the method of aspect 15, where a period of the periodic measurement sampling for the sub-sequence of the sensing measurement data corresponds to four slots.

Aspect 17 is the method of any of aspects 13 to 16, where the sensing node is at least one of a user equipment (UE) or a transmission-reception point (TRP).

Aspect 18 is the method of any of aspects 13 to 17, where the sensing entity is at least one of a network node or a network entity.

Aspect 19 is the method of aspect 18, where the uniform sampling periodicity for the set of Doppler operations is at least one of a first duration of a first slot that includes a symbol with a long cyclic prefix (CP), a second duration of a second slot that does not include any symbol with the long CP, or a third duration of an average slot length.

Aspect 20 is the method of any of aspects 13 to 19, where the reference signal has the uniform periodicity and each resource associated with the reference signal has a same cyclic prefix (CP) with a uniform CP length, where the same CP with the uniform CP length is at least one of a normal CP (NCP) or an extended CP (ECP).

Aspect 21 is the method of aspect 20, where the reference signal is at least one of a positioning reference signal (PRS) or a sounding reference signal (SRS) for positioning (SRS-pos), and where each resource associated with the reference signal is a dedicated time domain resource or a dedicated frequency domain resource.

Aspect 22 is an apparatus for wireless communication including means for implementing any of aspects 1 to 12.

Aspect 23 is a computer-readable medium (e.g., a non-transitory computer-readable medium) storing computer executable code, the code when executed by at least one processor causes the at least one processor to implement any of aspects 1 to 12.

Aspect 24 is an apparatus for wireless communication at a network node. The apparatus includes a memory; and at least one processor coupled to the memory and, based at least in part on information stored in the memory, the at least one processor is configured to implement any of aspects 1 to 12.

Aspect 25 is the apparatus of aspect 24, further including at least one of a transceiver or an antenna coupled to the at least one processor.

Aspect 26 is an apparatus for wireless communication including means for implementing any of aspects 13 to 21.

Aspect 27 is a computer-readable medium (e.g., a non-transitory computer-readable medium) storing computer executable code, the code when executed by at least one processor causes the at least one processor to implement any of aspects 13 to 21.

Aspect 28 is an apparatus for wireless communication at a network node. The apparatus includes a memory; and at least one processor coupled to the memory and, based at least in part on information stored in the memory, the at least one processor is configured to implement any of aspects 13 to 21.

Aspect 29 is the apparatus of aspect 28, further including at least one of a transceiver or an antenna coupled to the at least one processor.

What is claimed is:

1. An apparatus for wireless communications at a sensing node, comprising:
a memory; and
at least one processor coupled to the memory and, based at least in part on information stored in the memory, the at least one processor is configured to:
configure a uniform sampling periodicity for a set of Doppler operations based on a sampling configuration, wherein the uniform sampling periodicity is different from a non-uniform periodicity or a uniform periodicity of a received reference signal;
measure, based on the received reference signal, sensing measurement data associated with at least one sensing target; and
process one or more of the set of Doppler operations for at least one portion of the sensing measurement data according to the uniform sampling periodicity.

2. The apparatus of claim 1, wherein the at least one portion of the sensing measurement data is based on a periodic measurement sampling for a sub-sequence of the sensing measurement data.

3. The apparatus of claim 2, wherein to process the one or more of the set of Doppler operations for the at least one portion of the sensing measurement data, the at least one processor is configured to:
process two or more of the set of Doppler operations for at least two portions of the sensing measurement data according to the periodic measurement sampling for the sub-sequence of the sensing measurement data to generate two or more Doppler outputs, and
calculate an average of the two or more Doppler outputs associated with the two or more of the set of Doppler operations.

4. The apparatus of claim 3, wherein a period of the periodic measurement sampling for the sub-sequence of the sensing measurement data corresponds to four slots.

5. The apparatus of claim 1, wherein the sensing node is at least one of a user equipment (UE) or a transmission-reception point (TRP).

6. The apparatus of claim 1, wherein to configure the uniform sampling periodicity for the set of Doppler operations based on the sampling configuration, the at least one processor is configured to:
calculate a length of the uniform sampling periodicity or a frequency of the uniform sampling periodicity; and
configure the uniform sampling periodicity based on the length of the uniform sampling periodicity or the frequency of the uniform sampling periodicity.

7. The apparatus of claim 1, wherein the at least one processor is further configured to:
transmit, for a sensing entity, at least one of:
a set of results of processing the one or more of the set of Doppler operations for the at least one portion of the sensing measurement data; or
an indication of the uniform sampling periodicity configured for the set of Doppler operations.

8. The apparatus of claim 7, wherein the sensing entity is at least one of a network node or a network entity.

9. The apparatus of claim 8, wherein the uniform sampling periodicity for the set of Doppler operations is at least one of a first duration of a first slot that includes a symbol with a long cyclic prefix (CP), a second duration of a second slot that does not include any symbol with the long CP, or a third duration of an average slot length.

10. The apparatus of claim 1, wherein the at least one processor is further configured to:
receive, from a sensing entity, the sampling configuration prior to the configuration of the uniform sampling periodicity, wherein the sampling configuration indicates the uniform sampling periodicity for the set of Doppler operations.

11. The apparatus of claim 1, wherein the received reference signal has the uniform periodicity and each resource associated with the received reference signal has a same cyclic prefix (CP) with a uniform CP length, wherein the same CP with the uniform CP length is at least one of a normal CP (NCP) or an extended CP (ECP).

12. The apparatus of claim 11, wherein the received reference signal is at least one of a positioning reference signal (PRS) or a sounding reference signal (SRS) for positioning (SRS-pos), and wherein each resource associated with the received reference signal is a dedicated time domain resource or a dedicated frequency domain resource.

13. An apparatus for wireless communications at a sensing entity, comprising:
a memory; and
at least one processor coupled to the memory and, based at least in part on information stored in the memory, the at least one processor is configured to:
transmit, for a sensing node, a sampling configuration, wherein the sampling configuration indicates a uniform sampling periodicity for a set of Doppler operations, and wherein the uniform sampling periodicity is different from a non-uniform periodicity or a uniform periodicity of a reference signal; and
receive, from the sensing node, a set of results of processing one or more of the set of Doppler operations for at least one portion of sensing measurement data, wherein the sensing measurement data is associated with at least one sensing target and is based on the reference signal, and wherein the set of Doppler operations for the at least one portion of the sensing measurement data is based on the uniform sampling periodicity.

14. The apparatus of claim 13, wherein the at least one portion of the sensing measurement data is based on a periodic measurement sampling for a sub-sequence of the sensing measurement data.

15. The apparatus of claim 14, wherein the set of results of processing the one or more of the set of Doppler operations for the at least one portion of the sensing measurement data includes an average of two or more Doppler outputs associated with two or more of the set of Doppler operations, wherein the two or more of the set of Doppler operations are associated with at least two portions of the sensing measurement data according to the periodic measurement sampling for the sub-sequence of the sensing measurement data.

16. The apparatus of claim 15, wherein a period of the periodic measurement sampling for the sub-sequence of the sensing measurement data corresponds to four slots.

17. The apparatus of claim 13, wherein the sensing node is at least one of a user equipment (UE) or a transmission-reception point (TRP).

18. The apparatus of claim 13, wherein the sensing entity is at least one of a network node or a network entity.

19. The apparatus of claim 18, wherein the uniform sampling periodicity for the set of Doppler operations is at least one of a first duration of a first slot that includes a symbol with a long cyclic prefix (CP), a second duration of a second slot that does not include any symbol with the long CP, or a third duration of an average slot length.

20. The apparatus of claim 13, wherein the reference signal has the uniform periodicity and each resource associated with the reference signal has a same cyclic prefix (CP) with a uniform CP length, wherein the same CP with the uniform CP length is at least one of a normal CP (NCP) or an extended CP (ECP).

21. The apparatus of claim 20, wherein the reference signal is at least one of a positioning reference signal (PRS) or a sounding reference signal (SRS) for positioning (SRS-pos), and wherein each resource associated with the reference signal is a dedicated time domain resource or a dedicated frequency domain resource.

22. A method of wireless communications at a sensing node, comprising:
configuring a uniform sampling periodicity for a set of Doppler operations based on a sampling configuration, wherein the uniform sampling periodicity is different from a non-uniform periodicity or a uniform periodicity of a received reference signal;
measuring, based on the received reference signal, sensing measurement data associated with at least one sensing target; and
processing one or more of the set of Doppler operations for at least one portion of the sensing measurement data according to the uniform sampling periodicity.

23. The method of claim 22, wherein the at least one portion of the sensing measurement data is based on a periodic measurement sampling for a sub-sequence of the sensing measurement data.

24. The method of claim 23, wherein processing the one or more of the set of Doppler operations for the at least one portion of the sensing measurement data comprises:
processing two or more of the set of Doppler operations for at least two portions of the sensing measurement data according to the periodic measurement sampling for the sub-sequence of the sensing measurement data to generate two or more Doppler outputs, and
calculating an average of the two or more Doppler outputs associated with the two or more of the set of Doppler operations.

25. The method of claim 24, wherein a period of the periodic measurement sampling for the sub-sequence of the sensing measurement data corresponds to four slots.

26. The method of claim 25, wherein configuring the uniform sampling periodicity for the set of Doppler operations based on the sampling configuration comprises:
calculating a length of the uniform sampling periodicity or a frequency of the uniform sampling periodicity; and
configuring the uniform sampling periodicity based on the length of the uniform sampling periodicity or the frequency of the uniform sampling periodicity.

27. The method of claim 22, further comprising:
transmitting, for a sensing entity, a set of results of processing the one or more of the set of Doppler operations for the at least one portion of the sensing measurement data, wherein the sensing entity is at least one of a network node or a network entity; and wherein the uniform sampling periodicity for the set of Doppler operations is at least one of a first duration of a first slot that includes a symbol with a long cyclic prefix (CP), a second duration of a second slot that does not include any symbol with the long CP, or a third duration of an average slot length; and
receiving, from the sensing entity, the sampling configuration prior to the configuration of the uniform sampling periodicity, wherein the sampling configuration indicates the uniform sampling periodicity for the set of Doppler operations.

28. The method of claim 22, wherein the received reference signal has the uniform periodicity and each resource associated with the received reference signal has a same cyclic prefix (CP) with a uniform CP length, wherein the same CP with the uniform CP length is a normal CP (NCP).

29. The method of claim 28, wherein the received reference signal is at least one of a positioning reference signal (PRS) or a sounding reference signal (SRS) for positioning (SRS-pos), and wherein each resource associated with the received reference signal is a dedicated time domain resource or a dedicated frequency domain resource.

30. A method of wireless communications at a sensing entity, comprising:
transmitting, for a sensing node, a sampling configuration, wherein the sampling configuration indicates a uniform sampling periodicity for a set of Doppler operations, and wherein the uniform sampling periodicity is different from a non-uniform periodicity or a uniform periodicity of a reference signal; and
receiving, from the sensing node, a set of results of processing one or more of the set of Doppler operations for at least one portion of sensing measurement data, wherein the sensing measurement data is associated with at least one sensing target and is based on the reference signal, and wherein the set of Doppler operations for the at least one portion of the sensing measurement data is based on the uniform sampling periodicity.
